(19) United States
(12) Patent Application Publication
(10) Pub. No.: US 2025/0363672 A1
(43) Pub. Date: Nov. 27, 2025

(54) ENCODING METHOD, DECODING METHOD, CODE STREAM, ENCODER, DECODER, AND STORAGE MEDIUM

(71) Applicants: SHANGHAI JIAO TONG UNIVERSITY, Shanghai (CN); GUANGDONG OPPO MOBILE TELECOMMUNICATIONS CORP., LTD., Dongguan (CN)

(72) Inventors: Yiling XU, Dongguan (CN); Lizhi HOU, Dongguan (CN); Linyao GAO, Dongguan (CN); Honglian Wei, Dongguan (CN)

(73) Assignees: SHANGHAI JIAO TONG UNIVERSITY, Shanghai (CN); GUANGDONG OPPO MOBILE TELECOMMUNICATIONS CORP., LTD., Dongguan (CN)

(21) Appl. No.: 19/290,765

(22) Filed: Aug. 5, 2025

Related U.S. Application Data
(63) Continuation of application No. PCT/CN2023/079120, filed on Mar. 1, 2023.

(51) Int. Cl. G06T 9/00; G06T 9/40

(52) U.S. Cl. CPC G06T 9/001; G06T 9/40

(57) ABSTRACT

Disclosed in the embodiments of the present application are an encoding method, a decoding method, a code stream, an encoder, a decoder, and a storage medium. The decoding method comprises: decoding a code stream and determining a value of preset identification information; when the preset identification information indicates that a first quantization parameter of the current point cloud enables a target setting mode, determining a first feature value according to the current point cloud; and determining a value of the first quantization parameter according to the first feature value.

### CROSS-REFERENCE TO RELATED APPLICATIONS

This application is a continuation of International Application No. PCT/CN2023/079120, filed on Mar. 1, 2023, the disclosure of which is hereby incorporated by reference in its entirety.

### TECHNICAL FIELD

Embodiments of this application relate to the field of point cloud encoding and decoding technologies, and in particular, to an encoding method, a decoding method, a bitstream, an encoder, a decoder, and a storage medium.

### BACKGROUND

Currently, in an encoding and decoding framework of geometry-based point cloud compression (G-PCC), geometric information of a point cloud and attribute information corresponding to a point in the point cloud are separately encoded. Geometry coding in the G-PCC encoding and decoding framework may include octree geometry coding, predictive geometry coding, and geometry coding based on triangular patch fitting.

In predictive geometry coding, a value of a quantization parameter is generally set according to user experience. However, a specific transmission bandwidth is usually required in an actual application scenario. In this case, the quantization parameter is set improperly, resulting in failing to implement a reconstructed point cloud with optimal quality.

### SUMMARY

Embodiments of this application provide an encoding method, a decoding method, a bitstream, an encoder, a decoder, and a storage medium. A quantization parameter is set adaptively, so that reconstruction quality of a point cloud may be improved under a condition of a limited bit rate.

The technical solutions in embodiments of this application may be implemented as follows.

According to a first aspect, an embodiment of this application provides a decoding method, applied to a decoder, where the method includes:
decoding a bitstream, to determine a value of preset identification information;
when the preset identification information indicates that a target setting mode is enabled for a first quantization parameter of a current point cloud, determining a first feature value based on the current point cloud; and
determining a value of the first quantization parameter based on the first feature value.

According to a second aspect, an embodiment of this application provides an encoding method, applied to an encoder, where the method includes:
when a target setting mode is enabled for a first quantization parameter of a current point cloud, determining a first feature value based on the current point cloud; and
determining a value of the first quantization parameter based on the first feature value.

According to a third aspect, an embodiment of this application provides a bitstream, where the bitstream is generated by performing bit encoding on to-be-encoded information, and the to-be-encoded information at least includes: a value of preset identification information, a value of a first quantization parameter, a prediction residual absolute value, a quantity N of groups, or values of first quantization parameters corresponding to the N groups, where N is a positive integer.

According to a fourth aspect, an embodiment of this application provides an encoder, where the encoder includes a first determining unit and a first calculating unit, where
the first determining unit is configured to: when a target setting mode is enabled for a first quantization parameter of a current point cloud, determine a first feature value based on the current point cloud; and
the first calculating unit is configured to determine a value of the first quantization parameter based on the first feature value.

According to a fifth aspect, an embodiment of this application provides an encoder, including a first memory and a first processor, where
the first memory is configured to store a computer program runnable on the first processor; and
the first processor is configured to execute the method according to the second aspect when running the computer program.

According to a sixth aspect, an embodiment of this application provides a decoder, where the decoder includes a decoding unit, a second determining unit, and a second calculating unit, where
the decoding unit is configured to decode a bitstream, to determine a value of preset identification information;
the second determining unit is configured to: when the preset identification information indicates that a target setting mode is enabled for a first quantization parameter of a current point cloud, determine a first feature value based on the current point cloud; and
the second calculating unit is configured to determine a value of the first quantization parameter based on the first feature value.

According to a seventh aspect, an embodiment of this application provides a decoder, including a second memory and a second processor, where
the second memory is configured to store a computer program runnable on the second processor; and
the second processor is configured to execute the method according to the first aspect when running the computer program.

According to an eighth aspect, an embodiment of this application provides a computer-readable storage medium, where the computer-readable storage medium stores a computer program; and when the computer program is executed, the method according to the first aspect or the method according to the second aspect is implemented.

Embodiments of this application provide an encoding method, a decoding method, a bitstream, an encoder, a decoder, and a storage medium. At an encoding end, when a target setting mode is enabled for a first quantization parameter of a current point cloud, a first feature value is determined based on the current point cloud. Then, a value of the first quantization parameter is determined based on the first feature value. At a decoding end, first, a bitstream is decoded, to determine a value of preset identification information. Then, when the preset identification information indicates that the target setting mode is enabled for the first quantization parameter of the current point cloud, the first feature value is determined based on the current point cloud, and the value of the first quantization parameter is determined based on the first feature value.

### BRIEF DESCRIPTION OF DRAWINGS

FIG. 1 is a schematic diagram of a network architecture of point cloud encoding and decoding.

FIG. 2 is a schematic structural diagram of a GPCC encoding framework.

FIG. 3 is a schematic diagram of constructing a single-link tree.

FIG. 4 is a schematic flowchart 1 of a decoding method according to an embodiment of this application.

FIG. 5 is a schematic flowchart 2 of a decoding method according to an embodiment of this application.

FIG. 6 is a schematic flowchart 1 of an encoding method according to an embodiment of this application.

FIG. 7 is a schematic flowchart 2 of an encoding method according to an embodiment of this application.

FIG. 8 is a schematic structural diagram of an encoder according to an embodiment of this application.

FIG. 9 is a schematic structural diagram of specific hardware of an encoder according to an embodiment of this application.

FIG. 10 is a schematic structural diagram of a decoder according to an embodiment of this application.

FIG. 11 is a schematic structural diagram of specific hardware of a decoder according to an embodiment of this application.

FIG. 12 is a schematic structural diagram of an encoding and decoding system according to an embodiment of this application.

### DESCRIPTION OF EMBODIMENTS

To understand features and technical content of embodiments of this application in more detail, the following describes implementation of embodiments of this application in detail with reference to the accompanying drawings. The accompanying drawings are merely used for description, and are not intended to limit embodiments of this application.

Unless otherwise defined, all technical and scientific terms used in this specification have the same meaning as commonly understood by those skilled in the technical field of this application. The terms used herein are merely for the purpose of describing embodiments of this application, but are not intended to limit this application.

In the following descriptions, the term “some embodiments” describes a subset of all possible embodiments, but it may be understood that “some embodiments” may be the same subset or different subsets of all possible embodiments and may be combined without a conflict. It should also be noted that the term “first/second/third” used in embodiments of this application is merely used to distinguish between similar objects and does not represent a specific sequence of objects. It may be understood that “first/second/third” may be interchanged if allowed, so that embodiments of this application described herein may be implemented in a sequence other than the sequence illustrated or described herein.

The names and terms used in embodiments of this application are described before providing a more detailed description of embodiments of this application, and the names and terms used in embodiments of this application are applicable to the following explanations:
point cloud compression (PCC);
video-based point cloud compression (V-PCC or VPCC);
geometry-based point cloud compression (G-PCC or GPCC);
K-nearest neighbors (KNN);
region adaptive hierarchical transform (RAHT);
mean squared error (MSE); and
peak signal-to-noise ratio (PSNR).

A point cloud is a three-dimensional representation of a surface of an object. A point cloud (data) on a surface of an object may be collected by using a collection device such as an optoelectronic radar, a LiDAR device, a laser scanner, or a multi-angle camera.

The point cloud refers to a set of massive three-dimensional points, and a point in the point cloud may include position information of the point and attribute information of the point. For example, the position information of the point may be three-dimensional coordinate information of the point, and the position information of the point may also be referred to as geometric information of the point. For example, the attribute information of the point may include color information and/or reflectance, and the like. For example, the color information may be information in any type of color space. For example, the color information may be RGB information, where R represents red (R), G represents green (G), and B represents blue (B). For another example, the color information may be luma and chroma (YCbCr, YUV) information, where Y denotes luminance, Cb(U) denotes blue chroma, and Cr(V) denotes red chroma.

A point in a point cloud obtained according to a laser measurement principle may include three-dimensional coordinate information of the point and laser reflectance of the point. For another example, a point in a point cloud obtained according to a photographing measurement principle may include three-dimensional coordinate information of the point and color information of the point. For another example, a point in a point cloud obtained with reference to the laser measurement principle and the photographing measurement principle may include three-dimensional coordinate information of the point, laser reflectance of the point, and color information of the point.

According to acquisition methods, point clouds may be classified into the following three types.
Type 1: Static point cloud, for which an object is static, and a device for acquiring the point cloud is also static.
Type 2: Dynamic point cloud, for which an object is moving, but a device for acquiring the point cloud is static.
Type 3: Dynamically acquired point cloud, for which a device for acquiring the point cloud is moving.

For example, according to usage, point clouds are classified into the following two categories.
Category 1: machine perception point cloud, which may be used in scenarios such as an autonomous navigation system, a real-time inspection system, a geographic information system, a visual sorting robot, and a disaster relief robot.
Category 2: human eye perception point cloud, which may be used in point cloud application scenarios such as a digital cultural heritage, free viewpoint broadcasting, three-dimensional immersive communication, and three-dimensional immersive interaction.

That is, a point cloud is a set of massive points in three-dimensional space, and information about each point includes geometric information that describes a spatial position of the point and other attribute information, where common attribute information includes a color, reflectance, a normal vector, and the like. With development of three-dimensional reconstruction technologies and three-dimensional imaging technologies, point clouds are widely applied in fields such as virtual reality, immersive remote presentation, and three-dimensional printing. However, a three-dimensional point cloud usually includes a large quantity of points, and distribution of the points is disordered in space. In addition, each point usually has rich attribute information, resulting in a large data volume of the point cloud, thus causing a great challenge to storage and transmission of the point cloud. Therefore, a point cloud compression encoding technology is one of representative technologies of point cloud processing and application.

To date, the moving picture experts group (MPEG), as an international organization for standardization, has proposed two types of point cloud compression encoding technologies, that is, VPCC and GPCC. In VPCC, a three-dimensional point cloud is converted into a two- dimensional image by projecting, and the two-dimensional image is encoded by using an existing two-dimensional encoding tool. In GPCC, a point cloud is divided into a plurality of units level by level by using a hierarchical structure, and the entire point cloud is encoded by recording a division process by performing encoding.

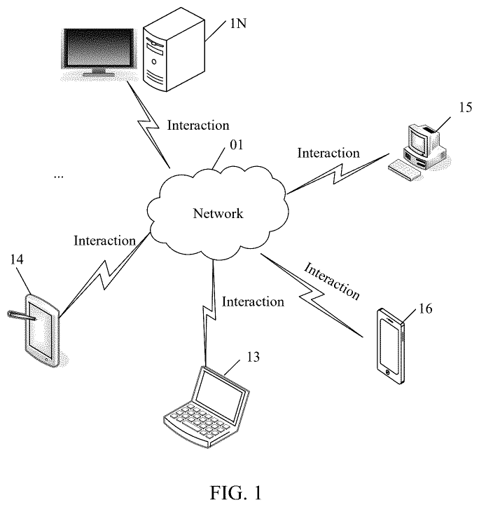

An embodiment of this application provides a network architecture of a point cloud encoding and decoding system for performing a decoding method and an encoding method. FIG. 1 is a schematic diagram of a network architecture of point cloud encoding and decoding according to an embodiment of this application. As shown in FIG. 1, the network architecture includes one or more electronic devices 13 to 1N and a communications network 01, where the electronic devices 13 to 1N may perform video interaction by using the communications network 01. The electronic devices may be implemented as various types of devices that have a point cloud encoding and decoding function. For example, the electronic devices may include a mobile phone, a tablet computer, a personal computer, a personal digital assistant, a navigator, a digital telephone, a video telephone, a television, a sensing device, and a server. This is not limited in embodiments of this application. A decoder or an encoder in embodiments of this application may be the foregoing electronic device.

The electronic device in this embodiment of this application has a point cloud encoding and decoding function, and generally includes a point cloud encoder (that is, an encoder) and a point cloud decoder (that is, a decoder).

It may be understood that this embodiment of this application is mainly targeted at further optimizing and improving encoding and decoding algorithms in GPCC. The following describes a related technology by using a GPCC encoding framework as an example.

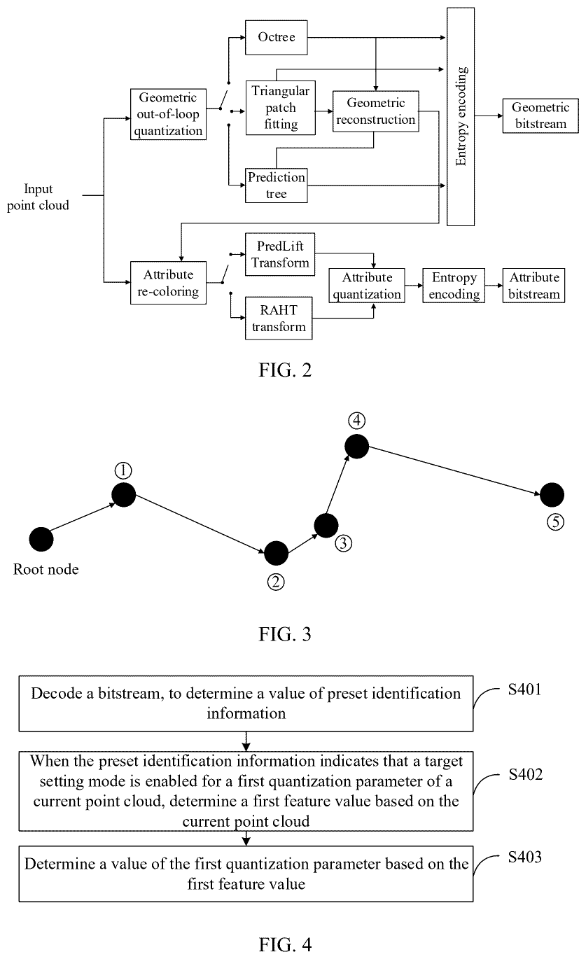

FIG. 2 is a schematic structural diagram of a GPCC encoding framework. As shown in FIG. 2, to-be-encoded point cloud data is first divided into a plurality of slices through slice division. In each slice, geometric information of the point cloud and attribute information of the point cloud are encoded separately. In a geometry encoding process, geometric out-of-loop quantization processing is first performed on an input voltage, and then processing such as octree processing, predictive processing, or triangular patch fitting is performed on the input voltage. In this processing process, entropy encoding is performed on each node in the point cloud, to generate a binary geometric bitstream. In an attribute encoding process, after the geometry encoding is completed and geometric information is reconstructed, a point cloud attribute needs to be re-colored first by using the reconstructed geometric information, so that attribute information that is not encoded corresponds to the reconstructed geometric information. Attribute encoding is mainly performed on color information. In a process of encoding the color information, there are mainly two transform methods. One method is predictive lift transform (PredLift Transform), and the other method is to directly perform region adaptive hierarchical transform (RAHT). In these two transform methods, the color information is transformed from a spatial domain to a frequency domain, to obtain a high-frequency coefficient and a low-frequency coefficient. Finally, attribute quantization is performed on the coefficients, and then entropy encoding is performed on the quantized coefficients, to generate a binary attribute bitstream.

In short, for geometry encoding, there are three optional encoding tools for GPCC, that is, octree geometry coding, predictive geometry coding, and geometry coding based on triangular patch fitting. In this embodiment of this application, a quantization parameter of a prediction tree is mainly set by using predictive geometry coding.

In a geometry coding algorithm of the prediction tree, points in a point cloud or a point cloud segment may be sorted in a sequence, a point ranked first is referred to as a root node (Root node). Starting from the root node, each time a remaining point set is searched for a point nearest to or approximately nearest to a current point, and the found point is used as a next node to construct a single-link tree until all points are added to the single-link tree. For details, one may refer to FIG. 3, which is a schematic diagram of constructing a singly-linked tree. In FIG. 3, a root node is first determined, a remaining point set is searched for a point nearest to or approximately nearest to the root node, and the found point is used as a node \textcircled{1}. Then, the remaining point set is searched for a point nearest to or approximately nearest to the node \textcircled{1}, and the found point is used as a node \textcircled{2}. The searching is performed until a node \textcircled{3}, a node \textcircled{4}, and a node \textcircled{5} are found, thereby constructing the single-link tree shown in FIG. 3. Then, geometric coordinates of the points are sequentially encoded in a sequence of the points regarding joining the single-link tree. When geometric coordinates of each point are encoded, geometric coordinates of a current point to be encoded are predicted by referring to geometric coordinates of points that have been encoded within a specific range before the current point according to an encoding sequence. Finally, a difference between true geometric coordinates of the current point and predicted geometric coordinates of the current point is encoded. It should be noted that a process performed at a decoding end is an inverse process of the foregoing encoding process.

It should be noted that a quantization operation generally incudes dividing a to-be-encoded value by a number greater than 1 at an encoding end, and correspondingly multiplying the number greater than 1 at the decoding end. Quantization may cause irreversible loss at the decoding end, but may effectively reduce a data transmission load. Different quantization degrees may be adapted to different scenarios and requirements.

It should be further noted that, in a process of predictive geometry coding, a quantization operation is performed in a maximum of two steps. Before a prediction tree is constructed, one time of quantization is performed on an input point, which is referred to as geometric out-of-loop quantization. After the prediction tree is constructed, one time of quantization is performed when a difference between true geometric coordinates and predicted geometric coordinates of each point is encoded, which is referred to as geometric in-loop quantization.

Further, attribute encoding is performed after geometry encoding is completed in GPCC. There are two optional methods for attribute encoding, that is, a method for predictive attribute encoding and a method for transformative attribute encoding. In the method for predictive attribute encoding, all points are first sorted in a sequence, and then attribute values of the points are encoded in the sequence. When the attribute value of each point is encoded, an attribute value of a current point to be encoded is predicted by referring to points that have been encoded within a specific range, and then a difference between a true attribute value and the predicted attribute value of the current point is encoded. In the method for transformative attribute encoding, an original attribute value is first transformed to a frequency domain, to obtain a series of low-frequency coefficients and high-frequency coefficients, and then these transform coefficients are encoded. Quantization in predictive attribute encoding and that in transformative attribute encoding both occur within a loop, that is, quantization is performed after a prediction residual is calculated or a transform coefficient is obtained through transform. This is referred to as attribute quantization herein.

It should be further noted that, a value of a quantization parameter is usually determined based on experience. However, a specific transmission bandwidth is usually required in an actual application scenario. How to set the quantization parameter according to the transmission bandwidth so as to obtain a reconstructed point cloud with optimal quality is an urgent problem to be resolved. However, among methods provided in a related technology, only a few methods attempt to establish mathematical models for transmission bandwidths and quantization parameters, but the methods usually lack optimization of reconstruction quality.

That is, in GPCC predictive geometry coding of the related technology, a quantization parameter is generally set according to user experience, and a bit rate requirement of an actual application scenario is not fully considered. As a result, under a transmission condition of a limited bit rate, there is no mature method for obtaining a reconstructed point cloud with optimal quality by properly setting the quantization parameter. In addition, in-loop quantization parameters of a prediction tree are generally set to a uniform value in different regions, without considering different point densities of different regions in the point cloud. Therefore, it is difficult to reduce a transmission load and maintain an important local feature of the point cloud by setting the in-loop quantization parameters.

Based on this, an embodiment of this application provides an encoding method. When a target setting mode is enabled for a first quantization parameter of a current point cloud, a first feature value is determined based on the current point cloud. Then, a value of the first quantization parameter is determined based on the first feature value.

An embodiment of this application further provides a decoding method. First, a bitstream is decoded, to determine a value of preset identification information. Then, when the preset identification information indicates that a target setting mode is enabled for a first quantization parameter of a current point cloud, a first feature value is determined based on the current point cloud. Then, a value of the first quantization parameter is determined based on the first feature value.

In this way, a decoding end may determine, by using only one piece of preset identification information, whether the target setting mode needs to be enabled for the current point cloud. Only when the target setting mode is enabled, the decoding end may adaptively set a quantization parameter according to the first feature value of the current point cloud. Therefore, a complicated operation of searching for an optimal quantization parameter by setting values of a plurality of groups of quantization parameters according to experience may be avoided. In addition, the quantization parameter is adjusted adaptively, so that a bit rate of the encoded point cloud can be close to a required bit rate of an actual application scenario, and optimal reconstruction quality can be achieved under a condition of a limited transmission bandwidth, thereby improving encoding and decoding performance of the point cloud.

The following describes embodiments of this application in detail with reference to the accompanying drawings.

Reference is made to FIG. 4, which is a schematic flowchart of a decoding method according to an embodiment of this application. As shown in FIG. 4, the method may include the following steps S401 to S403.

In S401, a bitstream is decoded to determine a value of preset identification information.

It should be noted that the decoding method according to embodiments of this application is applied to a decoder. In addition, the decoding method may specifically refer to a point cloud quantization decoding method, and more specifically, a method for setting a quantization parameter. Herein, adaptive setting of the quantization parameter may be implemented.

It should be further noted that, in embodiments of this application, the preset identification information may be one predefined indicator bit to be written into the bitstream, which is used to indicate whether to enable a target setting mode at an encoding end. The target setting mode refers to a mode in which a value of a quantization parameter is adaptively set, so that the value of the quantization parameter can be dynamically adjusted according to a feature of a current point cloud.

In some embodiments, for the value of the preset identification information, the method may further include:
if the value of the preset identification information is a first value, determining that the preset identification information indicates that the target setting mode is enabled for the first quantization parameter of the current point cloud; or
if the value of the preset identification information is a second value, determining that the preset identification information indicates that the target setting mode is not enabled for the first quantization parameter of the current point cloud.

In embodiments of this application, the first value is different from the second value, and the first value and the second value may be in a parametric form, or may be in a numeric form. Specifically, the preset identification information may be a parameter written into a profile, or may be a value of a flag, which is not specifically limited herein.

Exemplarily, for the first value and the second value, the first value may be set to 1,and the second value may be set to 0. Alternatively, the first value may be set to 0, and the second value may be set to 1. Alternatively, the first value may be set to true, and the second value may be set to false. Alternatively, the first value may be set to false, and the second value may be set to true. The first value and the second value are not specifically limited herein.

In embodiments of this application, it is assumed that the preset identification information is a flag to be written into the bitstream. If the first value is set to 1 and the second value is set to 0, when the value of the preset identification information is 1, it may be determined that the mode in which a value of a quantization parameter is adaptively set is enabled for the first quantization parameter of the current point cloud; or when the value of the preset identification information is 0, it may be determined that the mode in which a value of a quantization parameter is adaptively set is not enabled for the first quantization parameter of the current point cloud.

In S402, when the preset identification information indicates that the target setting mode is enabled for the first quantization parameter of the current point cloud, a first feature value is determined based on the current point cloud.

It should be noted that in embodiments of this application, the current point cloud may refer to a point cloud frame in a point cloud sequence, or may refer to a point cloud segment, which is not specifically limited herein.

In some embodiments, the first quantization parameter may include at least one of the following: a geometric in-loop quantization parameter, a geometric out-of-loop quantization parameter, or an attribute quantization parameter.

The first quantization parameter in embodiments of this application may refer to one of a geometric in-loop quantization parameter, a geometric out-of-loop quantization parameter, or an attribute quantization parameter, or may refer to a combination of any two of a geometric in-loop quantization parameter, a geometric out-of-loop quantization parameter, or an attribute quantization parameter, or may even refer to a combination of a geometric in-loop quantization parameter, a geometric out-of-loop quantization parameter, and an attribute quantization parameter. This is not specifically limited herein.

It should be further noted that, in embodiments of this application, a bit rate of the current point cloud is restricted by a requirement of an actual transmission bandwidth. A higher bit rate indicates a higher transmission bandwidth requirement, and a lower bit rate indicates a lower transmission bandwidth requirement.

In addition, there is a correspondence between the bit rate and a value of the first quantization parameter. Specifically, the bit rate of the current point cloud may include two parts, that is, a geometric bit rate and an attribute bit rate, which are respectively a bit rate required for decoding geometric information of the point cloud and a bit rate required for decoding attribute information of the point cloud. It should be noted that the geometric bit rate is affected by only the geometric out-of-loop quantization parameter and the geometric in-loop quantization parameter, but the attribute bit rate is affected by the geometric out-of-loop quantization parameter, the geometric in-loop quantization parameter, and the attribute quantization parameter.

It may be understood that in embodiments of this application, if the value of the preset identification information is the second value, that is, the target setting mode is not enabled for the first quantization parameter of the current point cloud, the value of the first quantization parameter is written into the bitstream. Therefore, in some embodiments, the method may further include: when the preset identification information indicates that the target setting mode is not enabled for the first quantization parameter of the current point cloud, decoding the bitstream, to determine the value of the first quantization parameter. In this case, because the value of the first quantization parameter has been written into the bitstream, a decoding end may directly decode the bitstream, to obtain the value of the first quantization parameter.

It may be further understood that, in embodiments of this application, if the target setting mode is enabled for the first quantization parameter of the current point cloud, that is, the value of the first quantization parameter is not written into the bitstream, the first feature value needs to be determined first based on the current point cloud. In a possible implementation, the process of determining the first feature value based on the current point cloud may include:
determining a prediction tree corresponding to the current point cloud; and
determining the first feature value based on a distance between each node and a previous node in the prediction tree.

It should be noted that in embodiments of this application, points in the current point cloud are sorted in a preset sequence, to construct a tree structure, which may be referred to as a prediction tree. The preset sequence may be an original collection sequence of the point cloud, a Morton sequence, a Hilbert sequence, or the like, which is not specifically limited herein.

It should be further noted that, in embodiments of this application, the process of determining the prediction tree corresponding to the current point cloud may include: determining a reference point set corresponding to the current point cloud; and constructing the prediction tree according to the reference point set. The reference point set may include at least one node in the current point cloud.

That is, the prediction tree herein may be constructed based on all the points in the current point cloud, or may be constructed based on some of the points in the current point cloud, which is not specifically limited herein.

Further, after the prediction tree is constructed, in a specific embodiment, the process of determining the first feature value based on the distance between each node and the previous node in the prediction tree structure may include: traversing the prediction tree, performing an accumulation operation on the distance between each node and the previous node in the prediction tree, to obtain a first accumulated value, and using the first accumulated value as the first feature value.

That is, in embodiments of this application, the entire prediction tree may be traversed in a sequence of points regarding joining the prediction tree, the distance between each node and the previous node in the prediction tree is accumulated, and the obtained first accumulated value is used as the first feature value.

Exemplarily, the geometric in-loop quantization parameter is used as an example. If the target setting mode is enabled for the geometric in-loop quantization parameter, that is, a mode of adaptively setting a value of the geometric in-loop quantization parameter is enabled at an encoding end, the geometric in-loop quantization parameter is not written into the bitstream. At the decoding end, the mode of adaptively setting the value of the geometric in-loop quantization parameter that is the same as that at the encoding end may be used, a geometric distance between each node and the previous node in the parsed prediction tree is accumulated, and an accumulated value is used as a feature variable that determines the value of the geometric in-loop quantization parameter, that is, the first feature value in embodiments of this application.

It may be further understood that, in embodiments of this application, if the target setting mode, that is, the mode of adaptively setting a value of a quantization parameter, is enabled for the first quantization parameter of the current point cloud, the first feature value may be determined based on the distance between each node and the previous node in the prediction tree, or may be determined based on another feature of the points in the prediction tree, for example, prediction residual absolute values of the points in the prediction tree. A determination manner of the first feature value is not specifically limited herein.

In another possible implementation, the process of determining the first feature value based on the current point cloud may include:
determining a prediction tree corresponding to the current point cloud; and
determining the first feature value based on a prediction residual absolute value of each node in the prediction tree.

It should be noted that in embodiments of this application, after the prediction tree is established, the first feature value may alternatively be determined based on a prediction residual absolute value of each node. In a specific embodiment, the process of determining the first feature value based on the prediction residual absolute value of each node in the prediction tree may include: traversing the prediction tree, performing an accumulation operation on the prediction residual absolute value of each node in the prediction tree, to obtain a second accumulated value, and using the second accumulated value as the first feature value.

It should be further noted that, in embodiments of this application, the prediction tree herein may be constructed based on all the points in the current point cloud, or may be constructed based on some points in the current point cloud, which is not specifically limited herein. Exemplarily, a reference point set may be determined based on the current point cloud, and then the prediction tree is determined based on the reference point set. The reference point set may include at least one node in the current point cloud.

In embodiments of this application, the entire prediction tree may be traversed in a sequence of points regarding joining the prediction tree, the prediction residual absolute value of each node in the prediction tree is accumulated, and the obtained second accumulated value is used as the first feature value. In addition, it should be noted that the decoding end may also construct a reference point set that is the same as that at the encoding end, accumulate prediction residual absolute value of each node in the reference point set, and use an obtained second accumulated value as the first feature value. The reference point set may include at least one node in the current point cloud.

Exemplarily, the geometric in-loop quantization parameter is still used as an example. If the target setting mode is enabled for the geometric in-loop quantization parameter, that is, the geometric in-loop quantization parameter is not written into the bitstream, and the encoding end determines that a feature variable of the geometric in-loop quantization parameter is a prediction residual absolute value. At the decoding end, the mode of adaptively setting the value of the geometric in-loop quantization parameter that is the same as that at the encoding end may be used, for example, a reference point set (or even an entire prediction tree) that is the same as that at the encoding end is constructed, prediction residual absolute values of all nodes in the reference point set are accumulated, and an accumulated value is used as the feature variable that determines the value of the geometric in-loop quantization parameter, that is, the first feature value described in this embodiment of this application.

It should be further noted that, in embodiments of this application, the prediction residual absolute value of each node may be an absolute value of a difference between true geometric coordinates and predicted geometric coordinates of each node. At the decoding end, in some embodiments, the method may further include: decoding the bitstream, to determine the prediction residual absolute value of each node in the prediction tree.

In this way, after calculating a prediction residual according to the true geometric coordinates and the predicted geometric coordinates of each node, the encoding end may write the prediction residual absolute value of each node into the bitstream, so that the decoding end can directly obtain the prediction residual absolute value of each node by decoding the bitstream. Further, when determining that the feature variable of the first quantization parameter is a prediction residual absolute value, the encoding end may determine the first feature value based on the prediction residual absolute value of each node.

In S403, the value of the first quantization parameter is determined based on the first feature value.

It should be noted that in embodiments of this application, the value of the first quantization parameter may be adaptively determined based on the first feature value corresponding to the current point cloud. The first quantization parameter may include at least one of the following: a geometric in-loop quantization parameter, a geometric out-of-loop quantization parameter, or an attribute quantization parameter.

It should be further noted that, in embodiments of this application, the value of the first quantization parameter may be determined based on a comparison between the first feature value and a reference feature value. In some embodiments, the process of determining the value of the first quantization parameter based on the first feature value may include:
determining the reference feature value of the current point cloud;
determining a feature comparison value based on the first feature value and the reference feature value; and
determining the value of the first quantization parameter based on the feature comparison value, a preset weight value, and a basic value of the first quantization parameter.

It may be understood that, in embodiments of this application, the reference feature value may be an empirical value for comparison with the feature variable. In a possible implementation, the reference feature value is a preset constant value. Exemplarily, the reference feature value may be a fixed value that is set according to experience.

In another possible implementation, the process of determining the reference feature value of the current point cloud may include: determining a preset reference range of the current point cloud; determining at least two second feature values based on the preset reference range; and performing mean value calculation on the at least two second feature values, to obtain the reference feature value.

Herein, the reference feature value may be a fixed value that is set by a user according to experience, or may be a mean value within a specific reference range. This is not specifically limited herein. In addition, it should be noted that for the specific reference range (for example, a preset reference range), if a point cloud is divided into a plurality of segments, the reference range may be a mean value of second feature values calculated by using segments near a current segment. Alternatively, for a point cloud sequence, the reference range may be a mean value of second feature values of one or more neighboring frames.

It may be further understood that, in embodiments of this application, the basic value of the first quantization parameter may be a preset constant value. That is, the basic value of the first quantization parameter may be an empirical value of the first quantization parameter, and the basic value is dynamically adjusted to determine the value of the first quantization parameter.

In some embodiments, for the basic value of the first quantization parameter, the method may further include: determining a preset calculation model; and determining the basic value of the first quantization parameter based on a target parameter of the current point cloud and the preset calculation model.

In embodiments of this application, the preset calculation model is used to indicate a mapping relationship between the target parameter and the first quantization parameter, and the target parameter includes a bit rate and/or reconstruction quality. Herein, the preset calculation model may be a mathematical model in different expression forms, such as a power-law model, a natural logarithm model, and an exponential model. Specifically, the preset calculation model is a mathematical model that can reflect a mapping relationship between the bit rate and the first quantization parameter, and/or a mathematical model that can reflect a mapping relationship between the reconstruction quality and the first quantization parameter. Exemplarily, a basic value may be set for the first quantization parameter according to the preset calculation model, and then the basic value is dynamically adjusted according to the feature comparison value and the preset weight value, to obtain the value of the first quantization parameter.

Further, in embodiments of this application, the first feature value may be denoted as d, the reference feature value may be denoted as d̅, the preset weight value may be denoted as k, the basic value of the first quantization parameter may be denoted as Q, and the value of the first quantization parameter may be denoted as Qᵢₙ.

In a possible implementation, the process of determining the value of the first quantization parameter based on the feature comparison value, the preset weight value, and the basic value of the first quantization parameter may include:
determining a first adjustment value based on the feature comparison value and the preset weight value; and
performing an addition operation on the first adjustment value and the basic value of the first quantization parameter, to obtain the value of the first quantization parameter.

Herein, the first adjustment value may be denoted as d/d̅. In this case, the value Qᵢₙ of the first quantization parameter may be calculated according to the following formula:

$${Q}_{in} = Q + k \frac{d}{\overline{d}} \qquad ( 1 )$$

In another possible implementation, the process of determining the value of the first quantization parameter based on the feature comparison value, the preset weight value, and the basic value of the first quantization parameter may include:
determining a second adjustment value based on the feature comparison value and the preset weight value; and
performing multiplication calculation on the second adjustment value and the basic value of the first quantization parameter, to obtain the value of the first quantization parameter.

Herein, the second adjustment value may be denoted as d/d̅. In this case, the value Qin of the first quantization parameter may be calculated according to the following formula:

$${Q}_{in} = Q * + k \frac{d}{\overline{d}} = kQ \frac{d}{\overline{d}} \qquad ( 2 )$$

It should be further noted that, the geometric in-loop quantization parameter is used as an example. For the formula (1) or the formula (2), Qᵢₙ is a value of the geometric in-loop quantization parameter, Q is an empirical value (that is, a basic value) of the geometric in-loop quantization parameter, d is an accumulated value of the current point cloud, d̅ is a mean value within the preset reference range, and k may also be referred to as an adjustment weight.

In some embodiments, for the first quantization parameter, for example, at least one of a geometric in-loop quantization parameter, a geometric out-of-loop quantization parameter, or an attribute quantization parameter, if the value of the first quantization parameter has been written into the bitstream, at the decoding end, the method may further include: decoding the bitstream, to determine the value of the first quantization parameter.

In some embodiments, for the first quantization parameter, because the geometric out-of-loop quantization parameter and the attribute quantization parameter are set in header information of a point cloud or a point cloud segment, each node cloud or a point cloud segment corresponds to a same geometric out-of-loop quantization parameter and a same attribute quantization parameter. However, each node cloud or each point cloud segment may be further divided into a plurality of groups, and different geometric in-loop quantization parameters may be further set in different local areas of the group.

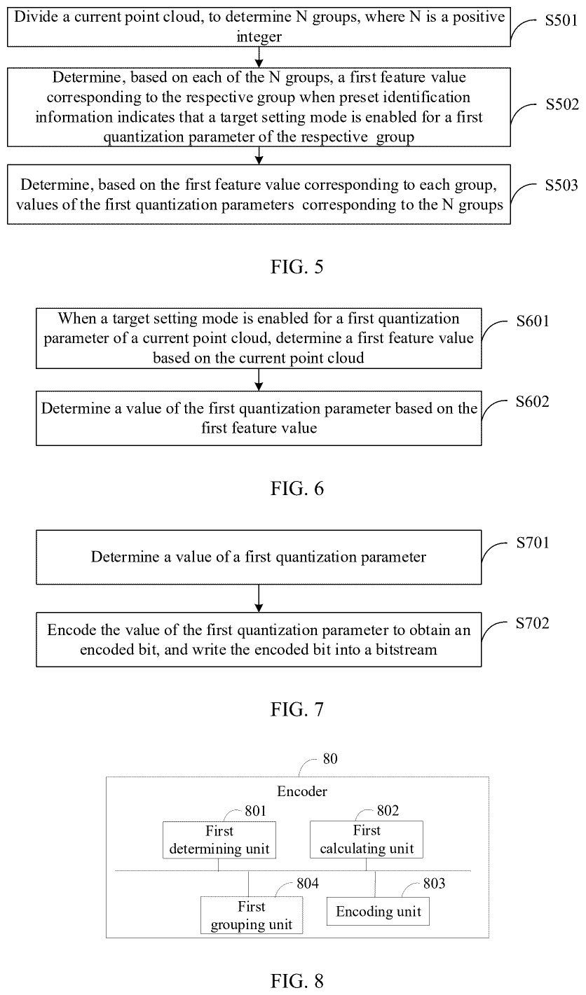

It may be understood that when the first quantization parameter is the geometric in-loop quantization parameter, the geometric in-loop quantization parameter may be set based on grouping. Therefore, in some embodiments, referring to FIG. 5, the method may include the following steps S501 to S503.

In S501, the current point cloud is divided to determine N groups, where N is a positive integer.

In S502, based on each of the N groups, a first feature value corresponding to the respective group is determined when the preset identification information indicates that the target setting mode is enabled for a first quantization parameter of the respective group.

In S503, based on the first feature value corresponding to each group, values of the first quantization parameters corresponding to the N groups are determined.

It should be noted that in embodiments of this application, the quantity N of groups of the current point cloud may be written into the bitstream. Therefore, in some embodiments, for the decoding end, the method may further include: decoding the bitstream to determine the quantity N of groups of the current point cloud. In addition, for a specific grouping manner, after the quantity N of groups is determined, the current point cloud may be evenly grouped according to a quantity of points. However, the current point cloud may alternatively be unevenly grouped according to another rule, which is not limited herein.

It should be further noted that, in embodiments of this application, after the grouping is performed, for each of the N groups, if the preset identification information indicates that the target setting mode is enabled for a first quantization parameter of the first group, the foregoing manner of adaptively setting a value of a quantization parameter may be used for the first group. If the preset identification information indicates that the target setting mode is not enabled for the first quantization parameter of the first group, the decoding end may decode the bitstream, to determine a value of the first quantization parameter of the first group. The first group is any one of the N groups.

In a possible implementation, if the preset identification information indicates that the target setting mode is enabled for the first quantization parameter of each group, the process of determining the first feature value corresponding to each group may include:
determining a sub-prediction tree corresponding to each group; and performing an accumulation operation on a distance between each node and a previous node in the sub-prediction tree, to determine the first feature value corresponding to each group.

In another possible implementation, if the preset identification information indicates that the target setting mode is enabled for the first quantization parameter of each group, the process of determining the first feature value corresponding to each group may include:
determining a sub-prediction tree corresponding to each group; and performing an accumulation operation on a prediction residual absolute value of each node in the sub-prediction tree, to determine the first feature value corresponding to each group.

It should be noted that in embodiments of this application, the first group in the N groups is used as an example. For a first feature value corresponding to the first group, a sub-prediction tree corresponding to the first group needs to be determined first, where the sub-prediction tree may include at least one node in the first group. Then, a distance between each node and a previous node in the sub-prediction tree may be accumulated, to determine the first feature value corresponding to the first group. Alternatively, a prediction residual absolute value of each node in the sub-prediction tree may be accumulated, to determine the first feature value corresponding to the first group. Alternatively, the decoding end may construct a reference point set that is the same as that at the encoding end, and accumulate a prediction residual absolute value of each node in the reference point set, to determine the first feature value corresponding to the first group. This is not specifically limited herein.

It should be further noted that, in embodiments of this application, after the first feature value corresponding to each group is determined, a value of a first quantization parameter corresponding to each group may further be determined based on the first feature value corresponding to each group. Specifically, the method may include: determining a reference feature value corresponding to each group; determining, based on the first feature value and the reference feature value corresponding to each group, a feature comparison value corresponding to each group; and determining, based on the feature comparison value, the preset weight value, and the basic value of the first quantization parameter, the value of the first quantization parameter corresponding to each group.

Exemplarily, the value of the first quantization parameter corresponding to each group may be calculated according to the formula (1) or the formula (2). In particular, for different groups, the reference feature value compared with the first feature value may be a mean value calculated by using feature variables of neighboring groups.

It should be further noted that, in embodiments of this application, not only the quantity N of groups of the current point cloud may be written into the bitstream, but also the values of the first quantization parameters corresponding to the N groups may be written into the bitstream. In this way, in some embodiments, for the decoding end, the method may further include: decoding the bitstream, to determine the values of the first quantization parameters corresponding to the N groups. In this way, if the encoding end sets a geometric in-loop quantization parameter based on grouping, the decoding end may first parse a quantity of groups and respective quantization parameters of different groups. Then, different values of the quantization parameters are respectively applied to points in the different groups according to a mapping relationship between the points and the groups.

Further, in a case in which no group exists, in some embodiments, after the determining the value of the first quantization parameter based on the first feature value, the method may further include:
decoding the bitstream, to determine a prediction residual value of a to-be-processed node in the current point cloud; performing dequantization processing on the prediction residual value of the to-be-processed node according to the value of the first quantization parameter, to determine a dequantization residual value of the to-be-processed node; and determining a reconstructed value of the to-be-processed node based on the dequantization residual value of the to-be-processed node.

Further, in a case in which groups exist, in some embodiments, after the determining, based on the first feature value corresponding to each group, the values of the first quantization parameters corresponding to the N groups, the method may further include:
decoding the bitstream, to determine a prediction residual value of a to-be-processed node in the current point cloud; determining, based on a mapping relationship between the to-be-processed node and the N groups, a value of a first quantization parameter corresponding to the to-be-processed node; performing dequantization processing on the prediction residual value of the to-be-processed node according to the value of the first quantization parameter, to determine a dequantization residual value of the to-be-processed node; and determining a reconstructed value of the to-be-processed node based on the dequantization residual value of the to-be-processed node.

It should be noted that for the reconstructed value of the to-be-processed node, a difference between grouping and no grouping lies in: if groups exist, a group to which the to-be-processed node belongs needs to be determined first, and different values of first quantization parameters are applied. In this way, the value of the first quantization parameter is dynamically set according to different segments of the point cloud, and a local feature of the point cloud may be maintained to a greater extent under a condition of a similar bit rate.

In a specific embodiment, the process of determining the reconstructed value of the to-be-processed node based on the dequantization residual value of the to-be-processed node may include: determining a predicted value of the to-be-processed node; and performing an addition operation on the dequantization residual value of the to-be-processed node and the predicted value of the to-be-processed node, to obtain the reconstructed value of the to-be-processed node.

It should be further noted that, in embodiments of this application, the predicted value of the to-be-processed node may be predicted in multiple manners. Exemplarily, a reference point set corresponding to the to-be-processed node is determined based on a preset traversal order, and the to-be-processed node is predicted according to the reference point set, to determine the predicted value of the to-be-processed node. When the prediction tree is being traversed, the reference point set may be a point set including a maximum of first k points in the traversal order, where k is a positive integer.

In a possible implementation, the process of determining the predicted value of the to-be-processed node may include: acquiring a reconstructed value of a previous node of the to-be-processed node according to a preset traversal order, and using the reconstructed value of the previous node as the predicted value of the to-be-processed node.

In another possible implementation, the process of determining the predicted value of the to-be-processed node may include: acquiring a reconstructed value of a previous node of the to-be-processed node and a reconstructed value of a node preceding the previous node of the to-be-processed node according to a preset traversal order, and determining the predicted value of the to-be-processed node based on the reconstructed value of the previous node and the reconstructed value of the node preceding the previous node.

When the entire prediction tree is traversed in a sequence of points regarding joining the prediction tree, for each traversed node, prediction of a geometric position of the to-be-processed node is used as an example. A prediction manner herein may be a mathematical transform of a point set including a maximum of first k points in the traversal order. Optionally, in a prediction manner, a geometric coordinate of the previous node is directly used as a predicted value of a geometric coordinate of the to-be-processed node. Optionally, in a prediction manner, the previous node of the to-be-processed node in the preset traversal order is denoted as p₀, and the node preceding the previous node of the to-be-processed node is denoted as p₁. In this case, a predicted value of a geometric coordinate of the to-be-processed node is 2p₀-p₁. There may be a plurality of prediction manners, which are not specifically limited herein.

In this way, in a case in which groups exist, it is assumed that a quantity of groups is equal to 3. In this case, a point cloud or a point cloud segment may be divided into three groups, a first feature value of each group is calculated, and different geometric in-loop quantization parameters are allocated according to the first feature values of different groups. Exemplarily, a larger geometric in-loop quantization parameter may be allocated to a group with a larger first feature value, and a smaller geometric in-loop quantization parameter may be allocated to a group with a smaller first feature value.

This embodiment provides a decoding method. First, a bitstream is decoded, to determine a value of preset identification information. Then, when the preset identification information indicates that a target setting mode is enabled for a first quantization parameter of a current point cloud, a first feature value is determined based on the current point cloud. Then, a value of the first quantization parameter is determined based on the first feature value. In this way, a decoding end may determine, by using only one piece of preset identification information, whether the target setting mode needs to be enabled for the current point cloud. Only when the target setting mode is enabled, a quantization parameter may be adaptively set according to the first feature value of the current point cloud. Therefore, a complicated operation of searching for an optimal quantization parameter by setting values of a plurality of groups of quantization parameters according to experience may be avoided. In addition, the quantization parameter is adjusted adaptively, so that a bit rate of the encoded point cloud can be close to a required bit rate of an actual application scenario, and optimal reconstruction quality can be achieved under a condition of a limited transmission bandwidth, thereby improving encoding and decoding performance of the point cloud.

Reference is made to FIG. 6, which is a schematic flowchart of an encoding method according to an embodiment of this application. As shown in FIG. 6, the method may include the following steps S601 and S602.

In S601, when a target setting mode is enabled for a first quantization parameter of a current point cloud, a first feature value is determined based on the current point cloud.

It should be noted that the encoding method according to embodiments of this application is applied to an encoder. In addition, the encoding method may specifically refer to a point cloud quantization encoding method, and more specifically, a method for setting a quantization parameter. Herein, adaptive setting of the quantization parameter may be implemented.

It should be further noted that, in embodiments of this application, one indicator bit may be predefined to be written into a bitstream herein. The predefined indicator bit may be referred to as preset identification information, which is used to indicate whether to enable the target setting mode at an encoding end. The target setting mode refers to a mode in which a value of a quantization parameter is adaptively set, so that the value of the quantization parameter can be dynamically adjusted according to a feature of the current point cloud.

In some embodiments, for the preset identification information, the method may further include:
determining a value of the preset identification information, where the preset identification information is used to indicate whether the target setting mode is enabled for the first quantization parameter of the current point cloud; and
encoding the value of the preset identification information to obtain an encoded bit, and writing the encoded bit into a bitstream.

In a specific embodiment, the process of determining the value of the preset identification information may include:
if the target setting mode is enabled for the first quantization parameter of the current point cloud, determining that the value of the preset identification information is a first value; or
if the target setting mode is not enabled for the first quantization parameter of the current point cloud, determining that the value of the preset identification information is a second value.

In embodiments of this application, the first value is different from the second value, and the first value and the second value may be in a parametric form, or may be in a numeric form. Specifically, the preset identification information may be a parameter written into a profile, or may be a value of a flag, which is not specifically limited herein.

Exemplarily, for the first value and the second value, the first value may be set to 1, and the second value may be set to 0. Alternatively, the first value may be set to 0, and the second value may be set to 1. Alternatively, the first value may be set to true, and the second value may be set to false. Alternatively, the first value may be set to false, and the second value may be set to true. The first value and the second value are not specifically limited herein.

In embodiments of this application, it is assumed that the preset identification information is a flag to be written into the bitstream. If the first value is set to 1 and the second value is set to 0, when the value of the preset identification information is 1, it may be determined that the mode in which a value of a quantization parameter is adaptively set is enabled for the first quantization parameter of the current point cloud. In this case, the value of the first quantization parameter is not written into the bitstream, and a decoding end may determine the value of the first quantization parameter by using the manner of adaptively setting a value of a quantization parameter that is the same as that at the encoding end. Alternatively, when the value of the preset identification information is 0, it may be determined that the mode in which a value of a quantization parameter is adaptively set is not enabled for the first quantization parameter of the current point cloud. In this case, the value of the first quantization parameter is written into the bitstream, and the decoding end may directly determine the value of the first quantization parameter by decoding the bitstream.

It may be understood that in embodiments of this application, the current point cloud may refer to a point cloud frame in a point cloud sequence, or may refer to a point cloud segment, which is not specifically limited herein.

In some embodiments, the first quantization parameter may include at least one of the following: a geometric in-loop quantization parameter, a geometric out-of-loop quantization parameter, or an attribute quantization parameter.

The first quantization parameter in embodiments of this application may refer to one of a geometric in-loop quantization parameter, a geometric out-of-loop quantization parameter, or an attribute quantization parameter, or may refer to a combination of any two of a geometric in-loop quantization parameter, a geometric out-of-loop quantization parameter, or an attribute quantization parameter, or may even refer to a combination of a geometric in-loop quantization parameter, a geometric out-of-loop quantization parameter, and an attribute quantization parameter. This is not specifically limited herein.

It should be further noted that, in embodiments of this application, a bit rate of the current point cloud is restricted by a requirement of an actual transmission bandwidth. A higher bit rate indicates a higher transmission bandwidth requirement, and a lower bit rate indicates a lower transmission bandwidth requirement.

In addition, there is a correspondence between the bit rate and a value of the first quantization parameter. Specifically, the bit rate of the current point cloud may include two parts, that is, a geometric bit rate and an attribute bit rate, which are respectively a bit rate required for decoding geometric information of the point cloud and a bit rate required for decoding attribute information of the point cloud. It should be noted that the geometric bit rate is only affected by the geometric out-of-loop quantization parameter and the geometric in-loop quantization parameter, but the attribute bit rate is affected by the geometric out-of-loop quantization parameter, the geometric in-loop quantization parameter, and the attribute quantization parameter.

It may be further understood that, in embodiments of this application, if the target setting mode is enabled for the first quantization parameter of the current point cloud, that is, the value of the first quantization parameter is unnecessary to be written into the bitstream, operations of the encoding end are similar to those of the decoding end, and the first feature value needs to be determined first based on the current point cloud. In a possible implementation, the process of determining the first feature value based on the current point cloud may include:
determining a prediction tree corresponding to the current point cloud; and
determining the first feature value based on a distance between each node and a previous node in the prediction tree.

It should be noted that in embodiments of this application, points in the current point cloud are sorted in a preset sequence, to construct a tree structure, which may be referred to as the prediction tree. The preset sequence may be an original collection sequence of the point cloud, a Morton sequence, a Hilbert sequence, or the like, which is not specifically limited herein.

It should be further noted that, in embodiments of this application, the process of determining the prediction tree corresponding to the current point cloud may include: determining a reference point set corresponding to the current point cloud; and constructing the prediction tree according to the reference point set. The reference point set may include at least one node in the current point cloud.

That is, the prediction tree herein may be constructed based on all the points in the current point cloud, or may be constructed based on some points in the current point cloud, which is not specifically limited herein.

Further, after the prediction tree is established, in a specific embodiment, the process of determining the first feature value based on the distance between each node and the previous node in the prediction tree may include: traversing the prediction tree, performing an accumulation operation on the distance between each node and the previous node in the prediction tree, to obtain a first accumulated value, and using the first accumulated value as the first feature value.

In embodiments of this application, the entire prediction tree may be traversed in a sequence of points regarding joining the prediction tree, the distance between each node and the previous node in the prediction tree is accumulated, and the obtained first accumulated value is used as the first feature value.

Exemplarily, the geometric in-loop quantization parameter is used as an example. If the target setting mode is enabled for the geometric in-loop quantization parameter, that is, a manner of adaptively setting a value of the geometric in-loop quantization parameter is enabled at the encoding end, a geometric distance between each node and the previous node in the parsed prediction tree may be accumulated at the encoding end, and an accumulated value is used as a feature variable that determines the value of the geometric in-loop quantization parameter, that is, the first feature value in embodiments of this application.

It may be further understood that, in embodiments of this application, if the target setting mode, that is, the manner of adaptively setting a value of a quantization parameter, is enabled for the first quantization parameter of the current point cloud, the first feature value may be determined based on the distance between each node and the previous node in the prediction tree, or may be determined based on another feature of the points in the prediction tree, for example, prediction residual absolute values of the points in the prediction tree. A determination manner of the first feature value is not specifically limited herein.

In another possible implementation, the process of determining the first feature value based on the current point cloud may include:
determining a prediction tree corresponding to the current point cloud; and
determining the first feature value based on a prediction residual absolute value of each node in the prediction tree.

It should be noted that in embodiments of this application, after the prediction tree is established, the first feature value may alternatively be determined based on a prediction residual absolute value of each node. In a specific embodiment, the process of determining the first feature value based on the prediction residual absolute value of each node in the prediction tree may include: traversing the prediction tree, performing an accumulation operation on the prediction residual absolute value of each node in the prediction tree, to obtain a second accumulated value, and using the second accumulated value as the first feature value.

It should be further noted that, in embodiments of this application, the prediction tree herein may be constructed based on all the points in the current point cloud, or may be constructed based on some points in the current point cloud, which is not specifically limited herein. Exemplarily, a reference point set may be determined based on the current point cloud, and then the prediction tree is determined based on the reference point set. The reference point set may include at least one node in the current point cloud.

In embodiments of this application, the entire prediction tree may be traversed in a sequence of points regarding joining the prediction tree, the prediction residual absolute value of each node in the prediction tree is accumulated, and the obtained second accumulated value is used as the first feature value. In addition, it should be noted that the encoding end may further construct a reference point set, accumulate a prediction residual absolute value of each node in the reference point set, and use an obtained second accumulated value as the first feature value. The reference point set may include at least one node in the current point cloud.

Exemplarily, the geometric in-loop quantization parameter is still used as an example. If the target setting mode is enabled for the geometric in-loop quantization parameter, and the encoding end determines that a feature variable of the geometric in-loop quantization parameter is a prediction residual absolute value, at the encoding end, a reference point set (or even an entire prediction tree) may be constructed first, a prediction residual absolute value of each node in the reference point set is accumulated, and an accumulated value is used as the feature variable that determines the value of the geometric in-loop quantization parameter, that is, the first feature value in this embodiment of this application.

It should be further noted that, in embodiments of this application, the prediction residual absolute value of each node may be an absolute value of a difference between true geometric coordinates and predicted geometric coordinates of each node. Therefore, in some embodiments, the method may further include:
determining a predicted value of each node in the prediction tree;
determining a prediction residual value of each node in the prediction tree based on a true value of each node in the prediction tree and the predicted value of each node in the prediction tree; and
calculating an absolute value of the prediction residual value of each node in the prediction tree, to obtain the prediction residual absolute value of each node in the prediction tree.

Herein, after the predicted value of each node in the prediction tree is obtained, an absolute value of a difference between the true value and the predicted value of each node may be calculated, to obtain the prediction residual absolute value of each node. By accumulating the prediction residual absolute values of all the nodes in the prediction tree, a feature variable that determines the value of the first quantization parameter can be determined.

In some embodiments, the process of determining the predicted value of each node in the prediction tree may include: determining, based on a preset traversal order, a reference point set corresponding to each node in the prediction tree, and predicting each node according to the reference point set, to determine the predicted value of each node.

It should be noted that in embodiments of this application, the predicted value of each node may be predicted in multiple manners. Exemplarily, the reference point set corresponding to each node in the prediction tree is determined based on the preset traversal order, and a corresponding node is predicted according to the reference point set, to determine a predicted value of the corresponding node. When the prediction tree is being traversed, the reference point set may be a point set including a maximum of first k points in the traversal order, where k is a positive integer.

In a possible implementation, the process of determining the predicted value of each node in the prediction tree may include: determining a reconstructed value of a previous node of each node in the prediction tree based on the preset traversal order, and using the reconstructed value of the previous node as the predicted value of each node.

In another possible implementation, the process of determining the predicted value of each node in the prediction tree may include: determining a reconstructed value of a previous node of each node in the prediction tree and a reconstructed value of a node preceding the previous node of each node based on the preset traversal order, and determining the predicted value of each node based on the reconstructed value of the previous node and the reconstructed value of the node preceding the previous node.

When the entire prediction tree is traversed in a sequence of points regarding joining the prediction tree, for each traversed node, prediction of a geometric position of a current node is used as an example. A prediction manner herein may be a mathematical transform of a point set including a maximum of first k points in the traversal order. Optionally, in a prediction manner, a geometric coordinate of a previous node is directly used as a predicted value of a geometric coordinate of the current node. Optionally, in a prediction manner, the previous node of the current node in the preset traversal order is denoted as p₀, and a node preceding the previous node of the current node is denoted as p₁. In this case, a predicted value of a geometric coordinate of the current node is 2pₒ-p₁. There may be a plurality of prediction manners, which are not specifically limited herein.

Further, in some embodiments, the method may further include: encoding the prediction residual absolute value of each node in the prediction tree to obtain an encoded bit, and writing the encoded bit into a bitstream.

In embodiments of this application, the decoding end cannot learn a true value of each node in the prediction tree. To facilitate determining of the first feature value corresponding to the current point cloud by the decoding end, the encoding end may write the prediction residual absolute value of each node in the prediction tree into the bitstream. In this way, subsequently, the decoding end can directly obtain the prediction residual absolute value of each node by decoding the bitstream. Therefore, when the encoding end determines that the feature variable of the first quantization parameter is a prediction residual absolute value, the decoding end may also determine the first feature value based on the prediction residual absolute value of each node.

In S602, the value of the first quantization parameter is determined based on the first feature value.

It should be noted that in embodiments of this application, the value of the first quantization parameter may be adaptively determined based on the first feature value corresponding to the current point cloud. The first quantization parameter may include at least one of the following: a geometric in-loop quantization parameter, a geometric out-of-loop quantization parameter, or an attribute quantization parameter.

It should be further noted that, in embodiments of this application, the value of the first quantization parameter may be determined based on a comparison between the first feature value and a reference feature value. In some embodiments, the process of determining the value of the first quantization parameter based on the first feature value may include:
determining the reference feature value of the current point cloud;
determining a feature comparison value based on the first feature value and the reference feature value; and
determining the value of the first quantization parameter based on the feature comparison value, a preset weight value, and a basic value of the first quantization parameter.

It may be understood that, in embodiments of this application, the reference feature value may be an empirical value for comparison with the feature variable. In a possible implementation, the reference feature value is a preset constant value. Exemplarily, the reference feature value may be a fixed value that is set according to experience.

In another possible implementation, the process of determining the reference feature value of the current point cloud may include: determining a preset reference range of the current point cloud; determining at least two second feature values based on the preset reference range; and performing mean value calculation on the at least two second feature values, to obtain the reference feature value.

Herein, the reference feature value may be a fixed value that is set by a user according to experience, or may be a mean value calculated according to a specific reference range. This is not specifically limited herein. In addition, it should be noted that for the specific reference range (for example, a preset reference range), if a point cloud is divided into a plurality of segments, the reference range may be a mean value of second feature values calculated by using segments near a current segment. Alternatively, for a point cloud sequence, the reference range may be a mean value of second feature values of one or more neighboring frames.

It may be further understood that, in embodiments of this application, the basic value of the first quantization parameter may be a preset constant value. That is, the basic value of the first quantization parameter may be an empirical value of the first quantization parameter, and is dynamically adjusted to determine the value of the first quantization parameter.

In some embodiments, for the basic value of the first quantization parameter, the method may further include: determining a preset calculation model; and determining the basic value of the first quantization parameter based on a target parameter of the current point cloud and the preset calculation model.

In embodiments of this application, the preset calculation model is used to indicate a mapping relationship between the target parameter and the first quantization parameter, and the target parameter includes a bit rate and/or reconstruction quality. Herein, the preset calculation model may be a mathematical model in different expression forms, such as a power-law model, a natural logarithm model, and an exponential model. Specifically, the preset calculation model is a mathematical model that can reflect a mapping relationship between the bit rate and the first quantization parameter, and/or a mathematical model that reflects a mapping relationship between the reconstruction quality and the first quantization parameter. Exemplarily, the basic value may be set for the first quantization parameter according to the preset calculation model, and then the basic value is dynamically adjusted according to the feature comparison value and the preset weight value, to obtain the value of the first quantization parameter.

Further, in embodiments of this application, the first feature value may be denoted as d, the reference feature value may be denoted as d̅, the preset weight value may be denoted as k, the basic value of the first quantization parameter may be denoted as Q, and the value of the first quantization parameter may be denoted as Qᵢₙ.

In a possible implementation, the process of determining the value of the first quantization parameter based on the feature comparison value, the preset weight value, and the basic value of the first quantization parameter may include:
determining a first adjustment value based on the feature comparison value and the preset weight value; and
performing an addition operation on the first adjustment value and the basic value of the first quantization parameter, to obtain the value of the first quantization parameter.

Herein, the first adjustment value may be denoted as d/d̅. In this case, the value Qᵢₙ of the first quantization parameter may be calculated according to the formula (1).

In another possible implementation, the process of determining the value of the first quantization parameter based on the feature comparison value, the preset weight value, and the basic value of the first quantization parameter may include:
determining a second adjustment value based on the feature comparison value and the preset weight value; and
performing multiplication calculation on the second adjustment value and the basic value of the first quantization parameter, to obtain the value of the first quantization parameter.

Herein, the second adjustment value may be denoted as d/d̅. In this case, the value Qᵢₙ of the first quantization parameter may be calculated according to the formula (2). It should be further noted that, the geometric in-loop quantization parameter is used as an example. For the formula (1) or the formula (2), Qᵢₙ is a value of the geometric in-loop quantization parameter, Q is an empirical value (that is, a basic value) of the geometric in-loop quantization parameter, d is an accumulated value of the current point cloud, d̅ is a mean value within the preset reference range, and k may also be referred to as an adjustment weight.

It may be further understood that, in embodiments of this application, for the first quantization parameter, for example, at least one of a geometric intra-loop quantization parameter, a geometric out-of-loop quantization parameter, or an attribute quantization parameter, if the manner of adaptively setting a value of a quantization parameter is not used at the decoding end, the encoding end needs to write the value of the first quantization parameter into the bitstream after determining the value of the first quantization parameter. In this way, for the decoding end, the value of the first quantization parameter may be determined by decoding the bitstream.

In some embodiments, when the target setting mode is not enabled for the first quantization parameter of the current point cloud, the method may include the following steps S701 and S702, as shown by FIG. 7.

In S701, the value of the first quantization parameter is determined.

In S702, the value of the first quantization parameter is encoded to obtain an encoded bit, and the encoded bit is written into a bitstream.

In embodiments of this application, if the value of the preset identification information is the second value, that is, the target setting mode is not enabled for the first quantization parameter of the current point cloud, the value of the first quantization parameter is written into the bitstream. The following describes setting of the first quantization parameter in detail with reference to several implementations.

In a possible implementation, the process of determining the value of the first quantization parameter may include:
determining a first calculation model; and
determining the value of the first quantization parameter based on a bit rate of the current point cloud and the first calculation model.

It should be noted that in embodiments of this application, the first calculation model is used to indicate a mapping relationship between the bit rate and the first quantization parameter. In this case, first, a mathematical model for the encoding bit rate and the first quantization parameter needs to be established, and a specific value of the first quantization parameter is determined based on the required encoding bit rate and by using the established mathematical model. Exemplarily, an expression of the mathematical model (that is, the first calculation model) is:

$$R = f ( Q ) \qquad ( 3 )$$

Herein, R is the encoding bit rate, Q is the first quantization parameter, and f(·) is a function expression of the first calculation model.

In a specific embodiment, the process of determining the first calculation model may include: determining a model parameter of the first calculation model.

It should be noted that in embodiments of this application, for the model parameter of the first calculation model, the method may include: determining a plurality of groups of sample values of the first quantization parameter; performing pre-encoding processing on the current point cloud according to the plurality of groups of sample values of the first quantization parameter, to obtain a plurality of sample bit rate values; and determining the model parameter of the first calculation model based on the plurality of groups of sample values of the first quantization parameter and the plurality of sample bit rate values.

In embodiments of this application, a method for determining an expression of the first calculation model may include: setting a plurality of groups of quantization parameter values according to empirical values, observing corresponding encoding bit rate results, and recording the results. This process is referred to as pre-encoding. Generally, for a point cloud sequence, a specific quantity of frames before the point cloud sequence are generally pre-encoded. After being established, the first calculation model is applied to a frame after the point cloud sequence. A single point cloud frame is generally pre-encoded.

Herein, the pre-encoding may be implemented as follows. A geometric in-loop quantization parameter and an attribute quantization parameter may be set to fixed values, only a geometric out-of-loop quantization parameter is changed, and a relationship between the geometric out-of-loop quantization parameter and a bit rate is fitted. Alternatively, a geometric out-of-loop quantization parameter and an attribute quantization parameter may be set to fixed values, only a geometric in-loop quantization parameter is changed, and a relationship between the geometric in-loop quantization parameter and a bit rate is fitted. Alternatively, a geometric out-of-loop quantization parameter and a geometric in-loop quantization parameter may be set to fixed values, only an attribute quantization parameter is changed, and a relationship between the attribute quantization parameter and a bit rate is fitted. It should be noted that an encoding bit rate of a point cloud may include two parts, that is, a geometric bit rate and an attribute bit rate, which are respectively a bit rate required for decoding geometric information of the point cloud and a bit rate required for decoding attribute information of the point cloud. The geometric bit rate is affected by only the geometric quantization parameters (the geometric out-of-loop quantization parameter and the geometric in-loop quantization parameter), but the attribute bit rate is affected by both the geometric quantization parameters (the geometric out-of-loop quantization parameter and the geometric in-loop quantization parameter) and the attribute quantization parameter.

In another specific embodiment, the method may further include: determining a plurality of first candidate models; determining, based on a sample value of the first quantization parameter, predicted bit rate values respectively corresponding to the plurality of first candidate models; performing fitting effect calculation according to the predicted bit rate values respectively corresponding to the plurality of first candidate models and true bit rate values, to obtain effect values respectively corresponding to the plurality of first candidate models; selecting a target model from the plurality of first candidate models according to the effect values respectively corresponding to the plurality of first candidate models; and determining the target model as the first calculation model.

It should be noted that in embodiments of this application, a plurality of expressions of common candidate models may be selected for fitting according to experience, and then a mathematical model with a best fitting effect is selected from the expressions, as an expression of a final mathematical model, that is, a final first calculation model.

It should also be noted that, the following exemplarily provides several expressions for the common candidate models. However, it should be noted that these empirical models are merely used as examples for illustration, and a finally adopted mathematical model is not limited to these expressions.

In some embodiments, an empirical mathematical model is a power-law model, which is specifically as follows:

$$R = {aQ}^{b} \qquad ( 4 )$$

Herein, both a and b are to-be-fitted model parameters, and Q is one of a geometric out-of-loop quantization parameter, a geometric in-loop quantization parameter, or an attribute quantization parameter.

In some embodiments, an empirical mathematical model is a natural logarithm model, which is specifically as follows:

$$R = clnQ + d \qquad ( 5 )$$

Herein, both c and d are to-be-fitted model parameters. It should be noted that the natural logarithm model is also equivalent to an e-based exponential model, which is specifically as follows:

$$Q = {fe}^{gQ} \qquad ( 6 )$$

Herein, f and g are to-be-fitted model parameters, and Q is one of a geometric out-of-loop quantization parameter, a geometric in-loop quantization parameter, or an attribute quantization parameter.

In some embodiments, an empirical mathematical model is a composite model of a natural logarithm model, which may be represented as follows:

$$R = ( {clnQ}_{1} + d ) {lnQ}_{2} + e \qquad ( 7 )$$

Herein, Q₁ and Q₂ are two of a geometric out-of-loop quantization parameter, a geometric in-loop quantization parameter, or an attribute quantization parameter, and c, d, and e are to-be-fitted model parameters.

In some embodiments, an empirical composite model of a power-law model may be represented as follows:

$$R = {hQ}_{1}^{i} + {jQ}_{2}^{k} \qquad ( 8 )$$

Herein, Q₁ and Q₂ are two of a geometric out-of-loop quantization parameter, a geometric in-loop quantization parameter, or an attribute quantization parameter, and i, j, k, and h are to-be-fitted model parameters.

It should be further noted that, in embodiments of this application, a fitting effect may be evaluated by using a fitting degree R² or a mean squared error MSE. That is, the effect values in embodiments of this application may at least include a fitting degree value or a mean squared error value, but are not specifically limited.

In some embodiments, the process of selecting the target model from the plurality of first candidate models according to the effect values respectively corresponding to the plurality of first candidate models may include:
if the effect values are fitting degree values, determining a maximum effect value from the effect values respectively corresponding to the plurality of first candidate models, and using a first candidate model corresponding to the maximum effect value as the target model; or
if the effect values are mean squared error values, determining a minimum effect value from the effect values respectively corresponding to the plurality of first candidate models, and using a first candidate model corresponding to the minimum effect value as the target model.

In a possible implementation, the fitting degree R² may be defined as follows:

$${R}^{2} = 1 - \frac{{\sum }_{i} {( {\hat{y}}_{i} - {y}_{i} )}^{2}}{{\sum }_{i} {( {\hat{y}}_{i} - \overline{y} )}^{2}} \qquad ( 9 )$$

Herein, ŷᵢ is a model prediction bit rate, yᵢ is an actual encoding bit rate, and y̅ is a mean value of encoding bit rates in an observation experiment. Generally, a larger value of R² indicates a better fitting effect.

In a possible implementation, the mean squared error MSE may be defined as follows:

$$M S E = \frac{1}{n} {\sum }_{i = 1}^{n} {( {\hat{y}}_{i} - {y}_{i} )}^{2} \qquad ( 10 )$$

Herein, n is a quantity of samples in the observation experiment, ŷᵢ is a model prediction bit rate, and yᵢ is an actual encoding bit rate. Generally, a smaller MSE indicates a better fitting effect.

In another possible implementation, the process of determining the value of the first quantization parameter may include:
determining a second calculation model; and
determining the value of the first quantization parameter based on reconstruction quality of the current point cloud and the second calculation model.

It should be noted that in embodiments of this application, the second calculation model is used to indicate a mapping relationship between the reconstruction quality and the first quantization parameter. In this case, first, a mathematical model for the reconstruction quality and the first quantization parameter needs to be established, and a specific value of the first quantization parameter is determined based on the required reconstruction quality and by using the established mathematical model. Exemplarily, an expression of the mathematical model (that is, the second calculation model) is:

$$D = g ( Q ) \qquad ( 11 )$$

Herein, D may be the reconstruction quality, and a larger value of D indicates better reconstruction quality; or D may be a loss of a reconstructed point cloud relative to an original point cloud, and a smaller value of D indicates better quality of the reconstructed point cloud; Q is the first quantization parameter, and g(·) is a function expression of the second calculation model.

It should be further noted that, the reconstruction quality may be represented by a peak signal-to-noise ratio (Peak Signal to Nosie Ration, PSNR), and a calculation manner is as follows:

$$p s n r = 10 {log}_{10} ( \frac{{p}^{2}}{M S E} ) \qquad ( 12 )$$

Herein, p denotes a peak signal value, which is determined by a feature of a data set; and MSE denotes an error between the reconstructed point cloud and the original point cloud. Herein, the error between the reconstructed point cloud and the original point cloud may be represented by multiple manners. This is not specifically limited.

In addition, not only a PSNR may be used as an indicator for the reconstruction quality, but also a subjective score, a mathematical model for predicting a subjective score of a user, performance of a specific application task, or the like may be used as an indicator for describing quality of the reconstructed point cloud. This is not specifically limited in embodiments of this application.

In this way, after an indicator for describing the reconstruction quality is determined, a mathematical model for the first quantization parameter and the reconstruction quality, that is, the second calculation model, may be established.

In a specific embodiment, the process of determining the second calculation model may include: determining a model parameter of the second calculation model.

It should be noted that in embodiments of this application, for the model parameter of the second calculation model, the method may include: determining a plurality of groups of sample values of the first quantization parameter; performing pre-encoding processing on the current point cloud according to the plurality of groups of sample values of the first quantization parameter, to obtain a plurality of sample reconstruction quality values; and determining the model parameter of the second calculation model based on the plurality of groups of sample values of the first quantization parameter and the plurality of sample reconstruction quality values.

In embodiments of this application, a method for determining an expression of the second calculation model may include: setting a plurality of groups of quantization parameter values according to empirical values, observing corresponding reconstruction quality results, and recording the results. This process is also referred to as pre-encoding. Generally, for a point cloud sequence, a specific quantity of frames before the point cloud sequence are generally pre-encoded. After being established, the second calculation model is applied to a frame after the point cloud sequence. A single point cloud frame is generally pre-encoded.

Herein, the pre-encoding may be implemented as follows. A geometric in-loop quantization parameter and an attribute quantization parameter may be set to fixed values, only a geometric out-of-loop quantization parameter is changed, and a relationship between the geometric out-of-loop quantization parameter and reconstruction quality is fitted. Alternatively, a geometric out-of-loop quantization parameter and an attribute quantization parameter may be set to fixed values, only a geometric in-loop quantization parameter is changed, and a relationship between the geometric in-loop quantization parameter and reconstruction quality is fitted. Alternatively, a geometric out-of-loop quantization parameter and a geometric in-loop quantization parameter may be set to fixed values, only an attribute quantization parameter is changed, and a relationship between the attribute quantization parameter and reconstruction quality is fitted.

In another specific embodiment, the method may further include: determining a plurality of second candidate models; determining, based on a sample value of the first quantization parameter, predicted reconstruction quality values respectively corresponding to the plurality of second candidate models; performing fitting effect calculation according to the predicted reconstruction quality values respectively corresponding to the plurality of second candidate models and true reconstruction quality values, to obtain effect values respectively corresponding to the plurality of second candidate models; selecting a target model from the plurality of second candidate models according to the effect values respectively corresponding to the plurality of second candidate models; and determining the target model as the second calculation model.

It should be noted that in embodiments of this application, a plurality of expressions of common second candidate models may be selected for fitting according to experience, and then a mathematical model with a best fitting effect is selected from the expressions, as an expression of a final mathematical model, that is, a final second calculation model. A manner of determining an expression of a bit rate mathematical model may also be used to determine an expression of a reconstruction quality mathematical model. In addition, the second candidate model may alternatively be a function expression such as a power-law model, a natural logarithm model, an exponential model, or a composite model of a power-law model or a natural logarithm model, which is not specifically limited herein.

It should be further noted that, in embodiments of this application, a fitting effect may be evaluated by using a fitting degree R² or a mean squared error MSE. That is, the effect values in embodiments of this application may at least include a fitting degree value or a mean squared error value, but are not specifically limited.

In some embodiments, the process of selecting the target model from the plurality of second candidate models according to the effect values respectively corresponding to the plurality of second candidate models may include:
if the effect values are fitting degree values, determining a maximum effect value from the effect values respectively corresponding to the plurality of second candidate models, and using a second candidate model corresponding to the maximum effect value as the target model; or
if the effect values are mean squared error values, determining a minimum effect value from the effect values respectively corresponding to the plurality of second candidate models, and using a second candidate model corresponding to the minimum effect value as the target model.

In embodiments of this application, the fitting degree R² may be defined as shown in the formula (9), and the mean squared error MSE may be defined as shown in the formula (10). Generally, a larger value of R² indicates a better fitting effect. Alternatively, a smaller MSE indicates a better fitting effect.

In still another possible implementation, the process of determining the value of the first quantization parameter may include:
determining a first calculation model and a second calculation model; and
performing optimal solution calculation according to the first calculation model and the second calculation model, to determine the value of the first quantization parameter.

It should be noted that in embodiments of this application, the first calculation model is used to indicate a mapping relationship between a bit rate and the first quantization parameter, and the second calculation model is used to indicate a mapping relationship between reconstruction quality and the first quantization parameter.

It should be further noted that, in embodiments of this application, an optimization problem is established according to a bit rate mathematical model and a reconstruction quality mathematical model, and an optimal value of the first quantization parameter is obtained by solving the optimization problem. The optimization problem may be expressed as follows:

$${min}_{Q} g ( Q ) \qquad ( 13 )$$

$$s . t . f ( Q ) \leq {R}_{target} \qquad ( 14 )$$

Herein, Q is the first quantization parameter, g(Q) and f(Q) are respectively a mathematical model expression of a reconstruction loss and a mathematical model expression of an encoding bit rate, and R_{target} denotes a target bit rate.

It may be understood that when the first quantization parameter is the geometric in-loop quantization parameter, the geometric in-loop quantization parameter may be further set based on grouping. Therefore, in some embodiments, the method may further include:
dividing the current point cloud, to determine N groups, where N is a positive integer;
determining, based on each of the N groups, a first feature value corresponding to the respective group when the target setting mode is enabled for a first quantization parameter of the respective group; and
determining, based on the first feature value corresponding to each group, values of the first quantization parameters corresponding to the N groups.

It should be noted that in embodiments of this application, the quantity N of groups of the current point cloud is written into the bitstream. Therefore, in some embodiments, the method may further include: encoding the quantity N of groups of the current point cloud to obtain an encoded bit, and writing the encoded bit into a bitstream. In this way, subsequently, at the decoding end, the quantity N of groups of the current point cloud may be directly determined by decoding the bitstream. In addition, for a specific grouping manner, after the quantity N of groups is determined, the current point cloud may be evenly grouped according to a quantity of points. Alternatively, the current point cloud may be unevenly grouped according to another rule, which is not limited herein.

It should be further noted that, in embodiments of this application, after the grouping is performed, for each of the N groups, if the target setting mode is enabled for a first quantization parameter of the first group, the foregoing manner of adaptively setting a value of a quantization parameter may be used for the first group. If the target setting mode is not enabled for the first quantization parameter of the first group, the value of the first quantization parameter may be determined based on the first calculation model and/or the second calculation model. The first group is any one of the N groups.

In a possible implementation, if the target setting mode is enabled for the first quantization parameter of each group, the process of determining the first feature value corresponding to each group may include:
determining a sub-prediction tree corresponding to each group; and performing an accumulation operation on a distance between each node and a previous node in the sub-prediction tree, to determine the first feature value corresponding to each group.

In another possible implementation, if the preset identification information indicates that the target setting mode is enabled for the first quantization parameter of each group, the process of determining the first feature value corresponding to each group may include:
determining a sub-prediction tree corresponding to each group; and performing an accumulation operation on a prediction residual absolute value of each node in the sub-prediction tree, to determine the first feature value corresponding to each group.

It should be noted that in embodiments of this application, the first group in the N groups is used as an example. For a first feature value corresponding to the first group, a sub-prediction tree corresponding to the first group needs to be determined first, where the sub-prediction tree may include at least one node in the first group. Then, a distance between each node and a previous node in the sub-prediction tree may be accumulated, to determine the first feature value corresponding to the first group. Alternatively, a prediction residual absolute value of each node in the sub-prediction tree may be accumulated, to determine the first feature value corresponding to the first group. Alternatively, the encoding end may construct a reference point set, and accumulate a prediction residual absolute value of each node in the reference point set, to determine the first feature value corresponding to the first group. This is not specifically limited herein.

It should be further noted that, in embodiments of this application, after the first feature value corresponding to each group is determined, a value of a first quantization parameter corresponding to each group may further be determined based on the first feature value corresponding to each group. Specifically, the method may include: determining a reference feature value corresponding to each group; determining, based on the first feature value and the reference feature value corresponding to each group, a feature comparison value corresponding to each group; and determining, based on the feature comparison value, the preset weight value, and the basic value of the first quantization parameter, the value of the first quantization parameter corresponding to each group.

Exemplarily, the value of the first quantization parameter corresponding to each group may be calculated according to the formula (1) or the formula (2). In particular, for different groups, the reference feature value compared with the first feature value may be a mean value calculated by using feature variables of neighboring groups.

It should be further noted that, in embodiments of this application, not only the quantity N of groups of the current point cloud may be written into the bitstream, but also the values of the first quantization parameters corresponding to the N groups may be written into the bitstream. In this way, in some embodiments, the method may further include: encoding the values of the first quantization parameters respectively corresponding to the N groups to obtain an encoded bit, and writing the encoded bit into a bitstream. In this way, if the encoding end sets a geometric in-loop quantization parameter based on grouping, subsequently, the decoding end may first parse a quantity of groups and respective quantization parameters of different groups. Then, different values of the quantization parameters are respectively applied to points in different groups according to a mapping relationship between the points and the groups.

Further, in some embodiments, the method may further include: determining a prediction residual value of a to-be-processed node in the current point cloud; determining, based on a mapping relationship between the to-be-processed node and the N groups, a value of a first quantization parameter corresponding to the to-be-processed node; performing quantization processing on the prediction residual value of the to-be-processed node according to the value of the first quantization parameter, to determine a quantization residual value of the to-be-processed node; and encoding the quantization residual value of the to-be-processed node to obtain an encoded bit, and writing the encoded bit into a bitstream.

It should be noted that after the prediction residual value of the to-be-processed node is determined, the value of the first quantization parameter corresponding to the to-be-processed node may be determined based on the mapping relationship between the to-be-processed node and the N groups. Then, quantization processing is performed on the prediction residual value of the to-be-processed node by using the value of the first quantization parameter. In this way, the value of the first quantization parameter is dynamically set according to different segments of the point cloud, and a local feature of the point cloud may be maintained to a greater extent under a condition of a similar bit rate.

In a specific embodiment, the process of determining the prediction residual value of the to-be-processed node in the current point cloud may include: determining a predicted value of the to-be-processed node; and performing a subtraction operation on a true value of the to-be-processed node and the predicted value of the to-be-processed node, to obtain the prediction residual value of the to-be-processed node.

It should be further noted that, in embodiments of this application, the predicted value of the to-be-processed node may be predicted in multiple manners herein. Exemplarily, a reference point set corresponding to the to-be-processed node is determined based on a preset traversal order, and the to-be-processed node is predicted according to the reference point set, to determine the predicted value of the to-be-processed node. When the prediction tree is being traversed, the reference point set may be a point set including a maximum of first k points in the traversal order, where k is a positive integer.

In a possible implementation, the process of determining the predicted value of the to-be-processed node may include: acquiring a geometric coordinate value of a previous node of the to-be-processed node according to a preset traversal order, and using the geometric coordinate value of the previous node as the predicted value of the to-be-processed node.

In another possible implementation, the process of determining the predicted value of the to-be-processed node may include: acquiring a geometric coordinate value of a previous node of the to-be-processed node and a geometric coordinate value of a node preceding the previous node of the to-be-processed node according to a preset traversal order, and determining the predicted value of the to-be-processed node based on the geometric coordinate value of the previous node and the geometric coordinate value of the node preceding the previous node.

When the entire prediction tree is traversed in a sequence of points regarding joining the prediction tree, for each traversed node, prediction of a geometric position of the to-be-processed node is used as an example. A prediction manner herein may be a mathematical transform of a point set including a maximum of first k points in the traversal order. Optionally, in a prediction manner, a geometric coordinate of the previous node is directly used as a predicted value of a geometric coordinate of the to-be-processed node. Optionally, in a prediction manner, the previous node of the to-be-processed node in the preset traversal order is denoted as p₀, and the node preceding the previous node of the to-be-processed node is denoted as p₁. In this case, a predicted value of a geometric coordinate of the to-be-processed node is 2p₀-p₁. There may be a plurality of prediction manners, which are not specifically limited herein.

In this way, in a case in which groups exist, it is assumed that a quantity of groups set by the encoding end is equal to 3. In this case, a point cloud or a point cloud segment may be divided into three groups, a first feature value of each group is calculated, and different geometric in-loop quantization parameters are allocated according to the first feature values of different groups. Exemplarily, a larger geometric in-loop quantization parameter may be allocated to a group with a larger first feature value, and a smaller geometric in-loop quantization parameter may be allocated to a group with a smaller first feature value.

In some embodiments, an embodiment of this application further provides a bitstream, where the bitstream may be generated by performing bit encoding on to-be-encoded information, and the to-be-encoded information includes at least one of the following:
a value of preset identification information, a value of a first quantization parameter, a prediction residual absolute value, or a quantity N of groups and values of first quantization parameters corresponding to the N groups, where N is a positive integer.

It should be noted that an encoding end may write the to-be-encoded information into the bitstream, and then a decoding end may acquire the information by decoding the bitstream. Exemplarily, if the encoding end writes the value of the preset identification information into the bitstream, at the decoding end, after the value of the preset identification information is obtained by decoding the bitstream, whether a target setting mode is enabled for the first quantization parameter of a current point cloud may be determined. If the encoding end sets a value of a quantization parameter based on grouping, at the decoding end, a quantity N of groups and values of first quantization parameters corresponding to the N groups may be directly obtained by decoding the bitstream.

The embodiments of this application provide an encoding method. When a target setting mode is enabled for a first quantization parameter of a current point cloud, a first feature value is determined based on the current point cloud. Then, a value of the first quantization parameter is determined based on the first feature value. In this way, a quantization parameter is adaptively set according to the first feature value of the current point cloud. Therefore, a complicated operation of searching for an optimal quantization parameter by setting values of a plurality of groups of quantization parameters according to experience may be avoided. In addition, the quantization parameter is adjusted adaptively, so that a bit rate of the encoded point cloud can be close to a required bit rate of an actual application scenario, and optimal reconstruction quality can be achieved under a condition of a limited transmission bandwidth, thereby improving encoding and decoding performance of the point cloud.

In still another embodiment of this application, based on the encoding method and the decoding method described in the foregoing embodiments, an actual application scenario is considered. Herein, a method for setting a quantization parameter is provided, to properly control a geometric out-of-loop quantization parameter, a geometric in-loop quantization parameter, and an attribute quantization parameter, so that an encoding bit rate is close to a required bit rate of the actual application scenario, and optimal reconstruction quality is achieved under a condition of a limited transmission bandwidth.

In a possible implementation, a method for setting a point cloud quantization parameter is proposed herein, where the method includes:
setting a quantization parameter at an encoding end according to a transmission bandwidth requirement, where the quantization parameter may include a geometric out-of-loop quantization parameter, a geometric in-loop quantization parameter, or an attribute quantization parameter of a point cloud.

Further, the method for setting a quantization parameter may be performed as follows.

First, a mathematical model for the quantization parameter and an encoding bit rate is established, and a specific value of the quantization parameter is determined based on a transmission bandwidth requirement and by using the established mathematical model. An expression of the mathematical model is shown in the formula (3). A higher bit rate indicates a higher transmission bandwidth requirement, and a lower bit rate indicates a lower transmission bandwidth requirement.

Next, a method for determining the expression of the mathematical model may include:
setting a plurality of groups of quantization parameter values according to empirical values, observing corresponding encoding bit rate results, and recording the results. This process is called pre-encoding. Generally, for a point cloud sequence, a specific quantity of frames before the sequence are generally pre-encoded. After being established, the mathematical model is applied to a frame after the sequence.

A single point cloud frame is usually pre-encoded.

It should be noted that a plurality of expressions of common mathematical models may be selected for fitting according to experience, and then a mathematical model with a best fitting effect is selected, as an expression of a final mathematical model.

In some embodiments, an indicator for evaluating a fitting effect may be a fitting degree R², or may be a mean squared error MSE. The fitting degree R² is defined as shown in the formula (9), and generally a larger value of R² indicates a better fitting effect. The mean squared error MSE is defined as shown in the formula (10), and generally a smaller MSE indicates a better fitting effect.

In some embodiments, an implementation method of pre-encoding includes: setting a geometric in-loop quantization parameter and an attribute quantization parameter to fixed values, changing only a geometric out-of-loop quantization parameter, and fitting a relationship between the geometric out-of-loop quantization parameter and a bit rate.

In some embodiments, an implementation method of pre-encoding includes: setting a geometric out-of-loop quantization parameter and an attribute quantization parameter to fixed values, changing only a geometric in-loop quantization parameter, and fitting a relationship between the geometric in-loop quantization parameter and a bit rate.

In some embodiments, an implementation method of pre-encoding includes: setting a geometric out-of-loop quantization parameter and a geometric in-loop quantization parameter to fixed values, changing only an attribute quantization parameter, and fitting a relationship between the attribute quantization parameter and a bit rate.

It should be noted that an encoding bit rate of a point cloud includes two parts, that is, a geometric bit rate and an attribute bit rate, which are respectively a bit rate required for encoding geometric information of the point cloud and a bit rate required for encoding attribute information of the point cloud. The geometric bit rate is affected by only the geometric quantization parameters, but the attribute bit rate is affected by both the geometric quantization parameters and the attribute quantization parameter.

In some embodiments, an empirical mathematical model is a power-law model, as shown in the formula (4). Herein, both a and b are to-be-fitted model parameters, and Q is one of a geometric out-of-loop quantization parameter, a geometric in-loop quantization parameter, or an attribute quantization parameter.

In some embodiments, an empirical mathematical model is a natural logarithm model, as shown in the formula (5). Herein, both c and d are to-be-fitted model parameters. It should be noted that the natural logarithm model is also equivalent to an e-based exponential model, as shown in the formula (6). Herein, f and g are to-be-fitted model parameters, and Q is one of a geometric out-of-loop quantization parameter, a geometric in-loop quantization parameter, or an attribute quantization parameter.

In some embodiments, an empirical mathematical model is a composite model of a power-law model and a natural logarithm model, which may be expressed as the formula (7). Herein, Q₁ and Q₂ are two of a geometric out-of-loop quantization parameter, a geometric in-loop quantization parameter, or an attribute quantization parameter, and c, d, and e are to-be-fitted model parameters.

In some embodiments, an empirical mathematical model is a composite model of a power-law model and a natural logarithm model, and may be expressed as the formula (8). Herein, Q₁ and Q₂ are two of a geometric out-of-loop quantization parameter, a geometric in-loop quantization parameter, or an attribute quantization parameter, and i, j, k, and h are to-be-fitted model parameters.

It should be noted that the foregoing empirical models are merely used as examples for illustration, and a finally adopted empirical mathematical model is not limited to the foregoing examples.

In another possible implementation, a value of a quantization parameter is set according to a mathematical model established through pre-encoding, a required bit rate, and reconstruction quality.

In some embodiments, a method for setting a value of a quantization parameter includes: when there is only one quantization parameter variable and another quantization parameter is set according to experience, directly calculating a value of the quantization parameter variable according to the mathematical model.

In some embodiments, a method for setting a value of a quantization parameter includes: when there are two or more quantization parameter variables and the variables include an attribute quantization parameter variable, preferentially setting a smaller value for geometric quantization to maintain as much geometric information as possible, in consideration of a geometric priority of a three-dimensional point cloud being higher than an attribute priority of the three-dimensional point cloud.

In some embodiments, a method for setting a value of a quantization parameter includes: establishing a mathematical model for reconstruction quality, and setting a value of a quantization parameter according to the mathematical model for reconstruction quality and a mathematical model for a bit rate.

In some embodiments, an indicator for describing reconstruction quality is a PSNR, and a calculation manner is shown in the formula (12). Herein, p denotes a peak signal value, which is determined by a feature of a data set; and MSE denotes an error between the reconstructed point cloud and the original point cloud. Herein, the error between the reconstructed point cloud and the original point cloud may be represented by multiple manners. This is not further limited.

In some embodiments, an indicator for describing reconstruction quality is a subjective score, that is, a subjective score provided by a user on quality of a reconstructed point cloud.

In some embodiments, an indicator for describing reconstruction quality is a mathematical model for predicting a subjective score of a user. That is, instead of scoring the reconstruction quality by an actual user, a mathematical model is established by analyzing a human-eye feature, to predict a possible score of the user. It should be noted that the mathematical model for predicting a subjective score of a user may be represented by multiple manners, which is not further limited.

In some embodiments, an indicator for describing reconstruction quality is performance of a specific application task, that is, a reconstructed point cloud is applied to a specific application task, and performance of the reconstructed point cloud in the task is recorded, as an indicator for describing quality of the reconstructed point cloud.

In this way, after an indicator for describing reconstruction quality is determined, a mathematical model for a quantization parameter and the reconstruction quality is established, and an expression of the mathematical model is shown in the formula (11). Herein, D may be the reconstruction quality, and a larger value of D indicates better reconstruction quality; or D may be a loss of a reconstructed point cloud relative to an original point cloud, and a smaller value of D indicates better quality of the reconstructed point cloud; Q is the quantization parameter, and g(·) is a function expression of an independent variable.

In some embodiments, a manner of determining an expression of a specific bit rate mathematical model may also be used to determine an expression of a specific reconstruction quality mathematical model.

An optimization problem is established according to a bit rate mathematical model and a reconstruction quality mathematical model, and an optimal quantization parameter value is obtained by solving the optimization problem. The optimization problem may be expressed as the formula (13) and the formula (14). Herein, Q is the quantization parameter, g(Q) and f(Q) are respectively a mathematical model expression of a reconstruction loss and a mathematical model expression of an encoding bit rate, and R_{target} denotes a target bit rate.

In still another possible implementation, a method for setting a quantization parameter is proposed herein. The method includes: setting a value of a geometric out-of-loop quantization parameter and a value of an attribute quantization parameter by using one of the foregoing methods or empirical values, and dynamically adjusting a value of a geometric in-loop quantization parameter according to a feature of a data set.

In some embodiments, one indicator bit is defined to be written into a bitstream, which indicates that adaptive setting of an in-loop quantization parameter is enabled at the encoding end.

Specifically, a method for adaptively setting a value of a geometric in-loop parameter may be performed as follows.

First, all points of a point cloud or a point cloud segment are sorted in a sequence. Then, a tree structure is established, and is referred to as a prediction tree. A point ranked the first is added to the prediction tree as a root node.

Starting from the root node, each point newly added to the prediction tree is referred to as a current node. Each time a remaining point set is searched for a point nearest to or approximately nearest to the current node, and the found point is used as a next node until all the points in the point cloud or the point cloud segment are added to the prediction tree.

In some embodiments, a method for setting a geometric in-loop parameter includes: traversing the entire prediction tree in a sequence of points regarding joining the prediction tree, accumulating a geometric distance between a next node and a previous node in the tree, and using an accumulated value as a feature variable that determines a value of the geometric in-loop parameter; and comparing the feature variable with an empirical value, to determine a final value of the geometric in-loop parameter.

In some embodiments, a method for setting a geometric in-loop parameter includes: traversing the entire prediction tree in a sequence of points regarding joining the prediction tree, and predicting a geometric position of a current node when traversing each node. A prediction manner may be a mathematical transform of a point set including a maximum of first k points in the traversal order. Optionally, in a prediction manner, a geometric coordinate of a previous node is directly used as a predicted value of a geometric coordinate of the current node. Optionally, in a prediction manner, the previous node of the current node in the traversal order is denoted as p₀, and a node preceding the previous node of the current node is denoted as p₁. In this case, a predicted value of a geometric coordinate of the current node is 2p₀-p₁. There may be a plurality of prediction manners, which are not further limited herein.

After a predicted value of each point is obtained, an absolute value of a difference between a true geometric coordinate and a predicted geometric coordinate is calculated, prediction residual absolute values of all nodes in the tree are accumulated, and an accumulated value is used as a feature variable that determines a value of the geometric in-loop parameter. Then, the feature variable is compared with an empirical value, to determine a final value of the geometric in-loop parameter.

In some embodiments, the empirical value compared with the feature variable is a fixed value set by a user according to experience. Optionally, in another manner, a mean value within a specific reference range may be calculated. For example, when a point cloud is divided into a plurality of segments, the reference range may be a mean value of accumulated residual values calculated by using segments near a current segment. When a point cloud sequence is encoded, the reference range may be a mean value of accumulated residual values of one or more neighboring frames.

In some embodiments, the process of comparing the feature variable with the empirical value, to determine the value of the geometric in-loop parameter may be implemented as shown in the formula (2), or may be implemented as shown in the formula (1). Herein, Qᵢₙ is the geometric in-loop quantization parameter, Q is an empirical value of the geometric in-loop quantization parameter, d is an accumulated value of a current point cloud segment or a current point cloud frame, d̅ is a mean value within the reference range, and k is an adjustment weight.

In some embodiments, the calculated geometric in-loop quantization parameter may be written into a bitstream. Alternatively, the geometric in-loop quantization parameter may not be written into a bitstream. In this case, the geometric in-loop quantization parameter is calculated again at the decoding end.

In some embodiments, the foregoing method for setting a geometric in-loop quantization parameter may also be applied to another quantization parameter. In a possible implementation, for a sequence point cloud, a geometric out-of-loop quantization parameter and an attribute quantization parameter are set to basic values according to the foregoing mathematical model. Then, for a specific frame, the basic values are dynamically adjusted in the manner of setting a geometric in-loop quantization parameter. In this case, the basic values are the foregoing empirical value.

In some embodiments, a method for setting a geometric in-loop quantization parameter includes: dividing a point cloud or a point cloud segment into a plurality of groups, where different quantization parameters are applied to different groups.

In some embodiments, the grouping includes: setting a quantity of groups, and performing even grouping according to the quantity of points.

In some embodiments, a value of a geometric in-loop quantization parameter for each group may be set in one of the foregoing value setting manners. In particular, the empirical value compared with the feature variable may be a mean value calculated by using feature variables of neighboring groups.

In some embodiments, a manner of setting a value of an in-loop quantization parameter based on grouping includes that: a value of an intra-group quantization parameter is correlated with a value of an intra-group feature quantity. For example, three groups of quantization parameters are set at the encoding end, a point cloud or a point cloud segment is divided into three groups, a feature quantity of each group is calculated, and different geometric in-loop quantization parameters are allocated according to a value of the feature quantity of each group. For example, a larger quantization parameter is allocated to a large feature quantity, and a smaller quantization parameter is allocated to a small feature quantity.

In the method for setting a geometric quantization parameter based on grouping, a quantity of groups and a value of a quantization parameter corresponding to each group should be written into a bitstream.

Further, if a value of a quantization parameter of the encoding end is written into the bitstream, the decoding end may decode the bitstream, to obtain the value of the quantization parameter.

In particular, if a value of an in-loop quantization parameter may be adaptively acquired by using a feature of a point cloud, the decoding is performed as follows. If the encoding end defines one indicator bit to be written into a bitstream, which indicates that the in-loop quantization parameter is set adaptively at the encoding end, whether an in-loop quantization method is enabled can be determined by parsing the indicator bit.

Then, bitstream data related to geometric coordinates of a prediction tree is parsed, and the geometric coordinates obtained through the parsing are coordinate values obtained after in-loop quantization.

In some embodiments, if a geometric in-loop quantization parameter is written into a bitstream, a value of the parameter is directly parsed.

In some embodiments, it is assumed that a geometric in-loop quantization parameter is not written into a bitstream, and the encoding end determines that a feature variable of the in- loop quantization parameter is a distance between each node and a previous node in the prediction tree. In this case, at the decoding end, a distance between each node and the previous node in the parsed prediction tree is accumulated, an accumulated value is used as a feature variable that determines a value of the in-loop quantization parameter, and the feature variable is compared with an empirical value, to determine a final value of the geometric in-loop quantization parameter.

In some embodiments, it is assumed that the encoding end determines that the feature variable of the in-loop quantization parameter is a prediction residual. In this case, at the decoding end, a reference point set that is the same as that at the encoding end may be constructed, predicted geometric coordinates of the reference point set are calculated and a prediction residual absolute value of each node is obtained by parsing the bitstream, these absolute values are accumulated, and an accumulated value is used as the feature variable that determines the value of the geometric in-loop quantization parameter. Then, the feature variable is compared with an empirical value, to determine a final value of the geometric in-loop quantization parameter.

In some embodiments, the process of comparing the feature variable with the empirical value, to determine the value of the geometric in-loop quantization parameter may be implemented as shown in the formula (2), or may be implemented as shown in the formula (1). Herein, Qᵢₙ is the geometric in-loop quantization parameter, Q is an empirical value of the geometric in-loop quantization parameter, d is an accumulated value of a current point cloud segment or a current point cloud frame, d̅ is a mean value within the reference range, and k is an adjustment weight.

In some embodiments, if the encoding end uses the method for setting a geometric in-loop quantization parameter based on grouping, at the decoding end, a quantity of groups and quantization parameters of different groups are first parsed. Then, different values of the quantization parameters are respectively applied to points in the different groups according to a mapping relationship between the points and the groups.

It should be noted that there is a correspondence between the decoding end and a method for setting an in-loop quantization parameter that is selected by the encoding end. In an actual implementation process, the encoding end and the decoding end generally select one method for setting an in-loop quantization parameter, or may support a plurality of methods. A selected method for setting a quantization parameter is indicated by using one flag bit to be written into a bitstream.

It should be further noted that, in embodiments of this application, the foregoing method for setting a quantization parameter may be applied to a hardware device, for example, an electronic device including an encoder and/or a decoder.

In embodiments of this application, specific implementations of the foregoing embodiments are described in detail. It may be learned that, according to the technical solutions of the foregoing embodiments, for the proposed method for setting a quantization parameter, a value of a quantization parameter is set according to a bit rate requirement in an actual scenario in consideration of an actual application scenario of a geometry-based point cloud codec, and optimal reconstruction quality is achieved under a condition of a limited bit rate. Through analysis of different features of different point cloud segments, the value of the quantization parameter is dynamically adjusted, to maintain more local features of a point cloud under a condition of a similar bit rate. In this way, by using the method for setting a quantization parameter that is proposed in the technical solutions of the this application, a value of a quantization parameter may be set according to a bit rate requirement in an actual scenario, thereby avoiding a complicated operation of searching for an optimal quantization parameter combination by setting values of a plurality of groups of quantization parameters according to experience, and achieving optimal reconstruction quality under a condition of a limited bit rate. In addition, an in-loop quantization parameter is adjusted dynamically, so that the value of the quantization parameter may be dynamically set according to different features of different segments of a point cloud, thereby maintaining a local feature of the point cloud to a greater extent under a condition of a similar bit rate.

Based on a same invention concept as the foregoing embodiments, FIG. 8 is a schematic structural diagram of an encoder according to an embodiment of this application. As shown in FIG. 8, the encoder 80 may include a first determining unit 801 and a first calculating unit 802.

The first determining unit 801 is configured to: when a target setting mode is enabled for a first quantization parameter of a current point cloud, determine a first feature value based on the current point cloud.

The first calculating unit 802 is configured to determine a value of the first quantization parameter based on the first feature value.

In some embodiments, referring to FIG. 8, the encoder 80 may further include an encoding unit 803.

The first determining unit 801 is further configured to determine a value of preset identification information, where the preset identification information is used to indicate whether the target setting mode is enabled for the first quantization parameter of the current point cloud.

The encoding unit 803 is configured to encode the value of the preset identification information to obtain an encoded bit, and write the encoded bit into a bitstream.

In some embodiments, the first determining unit 801 is further configured to: if the target setting mode is enabled for the first quantization parameter of the current point cloud, determine that the value of the preset identification information is a first value; or if the target setting mode is not enabled for the first quantization parameter of the current point cloud, determine that the value of the preset identification information is a second value.

In some embodiments, the first determining unit 801 is further configured to: determine a prediction tree corresponding to the current point cloud; and determine the first feature value based on a distance between each node and a previous node in the prediction tree.

In some embodiments, the first calculating unit 802 is further configured to: traverse the prediction tree, perform an accumulation operation on the distance between each node and the previous node in the prediction tree, to obtain a first accumulated value, and use the first accumulated value as the first feature value.

In some embodiments, the first determining unit 801 is further configured to: determine a prediction tree corresponding to the current point cloud; and determine the first feature value based on a prediction residual absolute value of each node in the prediction tree.

In some embodiments, the first calculating unit 802 is further configured to: traverse the prediction tree, perform an accumulation operation on the prediction residual absolute value of each node in the prediction tree, to obtain a second accumulated value, and use the second accumulated value as the first feature value.

In some embodiments, the first determining unit 801 is further configured to: determine a predicted value of each node in the prediction tree; and determine a prediction residual value of each node in the prediction tree based on a true value of each node in the prediction tree and the predicted value of each node in the prediction tree.

The first calculating unit 802 is further configured to calculate an absolute value of the prediction residual value of each node in the prediction tree, to obtain the prediction residual absolute value of each node in the prediction tree.

In some embodiments, the encoding unit 803 is further configured to encode the prediction residual absolute value of each node in the prediction tree to obtain an encoded bit, and write the encoded bit into a bitstream.

In some embodiments, the first determining unit 801 is further configured to: determine, based on a preset traversal order, a reference point set corresponding to each node in the prediction tree; and predict each node according to the reference point set, to determine the predicted value of each node.

In some embodiments, the first determining unit 801 is further configured to: determine a reconstructed value of a previous node of each node in the prediction tree based on a preset traversal order, and use the reconstructed value of the previous node as the predicted value of each node. Alternatively, the first determining unit 801 is further configured to: determine a reconstructed value of a previous node of each node in the prediction tree and a reconstructed value of a node preceding the previous node of each node based on a preset traversal order, and determine the predicted value of each node based on the reconstructed value of the previous node and the reconstructed value of the node preceding the previous node.

In some embodiments, the first determining unit 801 is further configured to: determine a reference feature value corresponding to a current point cloud; determine, based on the first feature value and the reference feature value, a feature comparison value; and determine the value of the first quantization parameter based on the feature comparison value, a preset weight value, and a basic value of the first quantization parameter.

In some embodiments, the reference feature value is a preset constant value.

In some embodiments, the first determining unit 801 is further configured to: determine a preset reference range of the current point cloud; determine at least two second feature values based on the preset reference range; and perform mean value calculation on the at least two second feature values, to obtain the reference feature value.

In some embodiments, the basic value of the first quantization parameter is a preset constant value.

In some embodiments, the first determining unit 801 is further configured to: determine a preset calculation model; and determine the basic value of the first quantization parameter based on a target parameter of the current point cloud and the preset calculation model, where the preset calculation model is used to indicate a mapping relationship between the target parameter and the first quantization parameter, and the target parameter includes a bit rate and/or reconstruction quality.

In some embodiments, the first determining unit 801 is further configured to determine a first adjustment value based on the feature comparison value and the preset weight value.

The first calculating unit 802 is further configured to perform an addition operation on the first adjustment value and the basic value of the first quantization parameter, to obtain the value of the first quantization parameter.

In some embodiments, the first determining unit 801 is further configured to determine a second adjustment value based on the feature comparison value and the preset weight value.

The first calculating unit 802 is further configured to perform multiplication calculation on the second adjusted value and the basic value of the first quantization parameter, to obtain the value of the first quantization parameter.

In some embodiments, the first quantization parameter includes at least one of the following: a geometric in-loop quantization parameter, a geometric out-of-loop quantization parameter, or an attribute quantization parameter.

In some embodiments, the first determining unit 801 is further configured to: when the target setting mode is not enabled for the first quantization parameter of the current point cloud, determine the value of the first quantization parameter.

The encoding unit 803 is further configured to encode the value of the first quantization parameter to obtain an encoded bit, and write the encoded bit into a bitstream.

In some embodiments, the first determining unit 801 is further configured to: determine a first calculation model; and determine the value of the first quantization parameter based on a bit rate of the current point cloud and the first calculation mode, where the first calculation model is used to indicate a mapping relationship between the bit rate and the first quantization parameter.

In some embodiments, the first determining unit 801 is further configured to: determine a second calculation model; and determine the value of the first quantization parameter based on reconstruction quality of the current point cloud and the second calculation model, where the second calculation model is used to indicate a mapping relationship between the reconstruction quality and the first quantization parameter.

In some embodiments, the first determining unit 801 is further configured to: determine a first calculation model and a second calculation model; and perform optimal solution calculation according to the first calculation model and the second calculation model, to determine the value of the first quantization parameter, where the first calculation model is used to indicate a mapping relationship between a bit rate and the first quantization parameter, and the second calculation model is used to indicate a mapping relationship between reconstruction quality and the first quantization parameter.

In some embodiments, the first determining unit 801 is further configured to: determine a plurality of first candidate models; determine, based on a sample value of the first quantization parameter, predicted bit rate values corresponding to the plurality of first candidate models; perform fitting effect calculation on the predicted bit rate values corresponding to the plurality of first candidate models and true bit rate values, to obtain effect values corresponding to the plurality of first candidate models; select a target model from the plurality of first candidate models according to the effect values corresponding to the plurality of first candidate models; and determine the target model as the first calculation model.

In some embodiments, the effect values at least include a fitting degree value or a mean squared error value. Correspondingly, the first determining unit 801 is further configured to: if the effect values are fitting degree values, determine a maximum effect value from the effect values corresponding to the plurality of first candidate models, and use a first candidate model corresponding to the maximum effect value as the target model; or if the effect values are mean squared error values, determine a minimum effect value from the effect values corresponding to the plurality of first candidate models, and use a first candidate model corresponding to the minimum effect value as the target model.

In some embodiments, the first determining unit 801 is further configured to: determine a plurality of second candidate models; determine, based on a sample value of the first quantization parameter, predicted quality values corresponding to the plurality of second candidate models; perform fitting effect calculation on the predicted quality values corresponding to the plurality of second candidate models and true reconstruction quality values, to obtain effect values corresponding to the plurality of second candidate models; select a target model from the plurality of second candidate models according to the effect values corresponding to the plurality of second candidate models; and determine the target model as the second calculation model.

In some embodiments, the first determining unit 801 is further configured to determine a model parameter of the first calculation model.

In some embodiments, the first determining unit 801 is further configured to: determine a plurality of groups of sample values of the first quantization parameter; perform pre-encoding processing on the current point cloud according to the plurality of groups of sample values of the first quantization parameter, to obtain a plurality of sample bit rate values; and determine the model parameter of the first calculation model based on the plurality of groups of sample values of the first quantization parameter and the plurality of sample bit rate values.

In some embodiments, the first determining unit 801 is further configured to determine a model parameter of the second calculation model.

In some embodiments, the first determining unit 801 is further configured to: determine a plurality of groups of sample values of the first quantization parameter; perform pre-encoding processing on the current point cloud according to the plurality of groups of sample values of the first quantization parameter, to obtain a plurality of sample reconstruction quality values; and determine the model parameter of the second calculation model based on the plurality of groups of sample values of the first quantization parameter and the plurality of sample reconstruction quality values.

In some embodiments, referring to FIG. 8, the encoder 80 may further include a first grouping unit 804. The grouping unit 804 is configured to: when the first quantization parameter is a geometric in-loop quantization parameter, divide the current point cloud, to determine N groups, where N is a positive integer; determine, based on each of the N groups, a first feature value corresponding to the respective group when the target setting mode is enabled for a first quantization parameter of the respective group; and determine, based on the first feature value corresponding to each group, values of the first quantization parameters corresponding to the N groups.

In some embodiments, the first determining unit 801 is further configured to: determine a sub-prediction tree corresponding to each group; and perform an accumulation operation on a distance between each node and a previous node in the sub-prediction tree, to determine the first feature value corresponding to each group.

In some embodiments, the first determining unit 801 is further configured to: determine a sub-prediction tree corresponding to each group; and perform an accumulation operation on a prediction residual absolute value of each node in the sub-prediction tree, to determine the first feature value corresponding to each group.

In some embodiments, the encoding unit 803 is further configured to encode the quantity N of groups of the current point cloud to obtain an encoded bit, and write the encoded bit into a bitstream.

In some embodiments, the encoding unit 803 is further configured to encode the values of the first quantization parameters corresponding to the N groups to obtain an encoded bit, and write the encoded bit into a bitstream.

In some embodiments, the first grouping unit 804 is further configured to: determine a prediction residual value of a to-be-processed node in the current point cloud; determine, based on a mapping relationship between the to-be-processed node and the N groups, a value of a first quantization parameter corresponding to the to-be-processed node; and perform quantization processing on the prediction residual value of the to-be-processed node according to the value of the first quantization parameter, to determine a quantization residual value of the to-be-processed node.

The encoding unit 803 is further configured to encode the quantization residual value of the to-be-processed node to obtain an encoded bit, and write the encoded bit into a bitstream.

In some embodiments, the first determining unit 801 is further configured to determine a predicted value of the to-be-processed node.

The first calculating unit 802 is further configured to perform a subtraction operation on a true value of the to-be-processed node and the predicted value of the to-be-processed node, to obtain the prediction residual value of the to-be-processed node.

It may be understood that, in embodiments of this application, the term “unit” may be a partial circuit, a partial processor, a partial program or software, or the like. Certainly, the term “unit” may be a module or may be in a non-modular form. In addition, component parts in embodiments may be integrated into one processing unit, or each of the units may exist alone physically, or two or more units may be integrated into one unit. The foregoing integrated unit may be implemented in a form of hardware, or may be implemented in a form of a software functional module.

When the integrated unit is implemented in a form of a software functional module and not sold or used as an independent product, the integrated unit may be stored in a computer-readable storage medium. Based on such an understanding, the technical solutions of embodiments essentially, or the part contributing to the conventional technology, or all or some of the technical solutions may be implemented in a form of a software product. The computer software product is stored in a storage medium and includes several instructions for instructing a computer device (which may be a personal computer, a server, or a network device) or a processor (processor) to execute all or some of the steps of the methods described in the embodiments. The foregoing storage medium includes various media that may store a program code, such as a USB flash drive, a removable hard disk, a read-only memory (Read Only Memory, ROM), a random access memory (Random Access Memory, RAM), a magnetic disk, or an optical disc.

Therefore, an embodiment of this application provides a computer-readable storage medium, applied to an encoder 80. The computer-readable storage medium stores a computer program, and the computer program is executed by a first processor to implement the method according to any one of the foregoing embodiments.

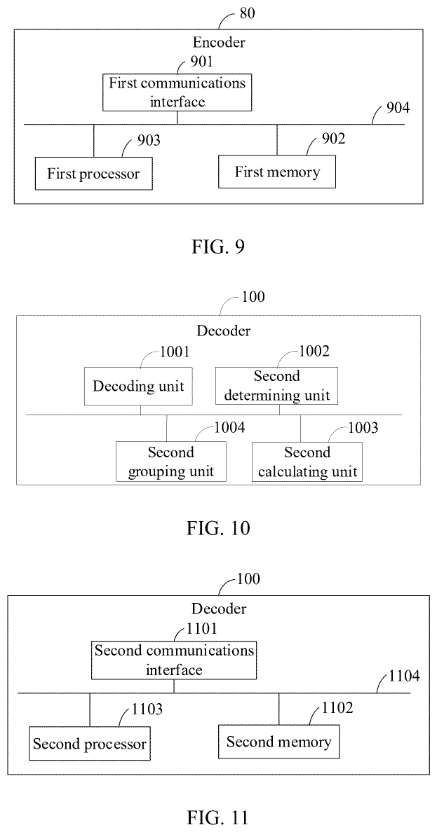

Based on the composition of the encoder 80 and the computer-readable storage medium, FIG. 9 is a schematic diagram of a structure of specific hardware of the encoder 80 according to an embodiment of this application. As shown in FIG. 9, the encoder 80 may include a first communications interface 901, a first memory 902, and a first processor 903. The components are coupled together by using a first bus system 904. It may be understood that the first bus system 904 is configured to implement connection and communication between these components. The first bus system 904 may further include a power bus, a control bus, a status signal bus, and the like, in addition to a data bus. However, for clarity of description, various buses are marked as the first bus system 904 in FIG. 9.

The first communications interface 901 is configured to receive and transmit signals in the process of transmitting and receiving information with other external network elements.

The first memory 902 is configured to store a computer program runnable on the first processor 903.

The first processor 903 is configured to run the computer program to execute the following operations:
when a target setting mode is enabled for a first quantization parameter of a current point cloud, determining a first feature value based on the current point cloud; and
determining a value of the first quantization parameter based on the first feature value.

It may be understood that, in embodiments of this application, the first memory 902 may be a volatile memory or a non-volatile memory, or may include both a volatile memory and a non-volatile memory. The non-volatile memory may be a read-only memory (Read-Only Memory, ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (Random Access Memory, RAM), and is used as an external cache. By way of example rather than limitative description, many forms of RAMs are available, for example, a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synchlink dynamic random access memory (Synchlink DRAM, SLDRAM), and a direct Rambus random access memory (Direct Rambus RAM, DRRAM). The first memory 902 in the systems and the methods described in this application include but are not limited to these and any memory of another appropriate type.

However, the first processor 903 may be an integrated circuit chip having a signal processing capability. In an implementation process, steps in the foregoing method can be implemented by using a hardware integrated logical circuit in the first processor 903, or by using instructions in a form of software. The foregoing first processor 903 may be a general-purpose processor, a digital signal processor (Digital Signal Processor, DSP), an application-specific integrated circuit (Application Specific Integrated Circuit, ASIC), a field-programmable gate array (Field Programmable Gate Array, FPGA) or another programmable logic device, a discrete gate or transistor logic device, or a discrete hardware component. The processor may implement or execute the methods, steps, and logical block diagrams disclosed in embodiments of this application. The general-purpose processor may be a microprocessor, or the processor may be any conventional processor or the like. The steps of the methods disclosed with reference to embodiments of this application may be directly executed by a hardware decoding processor, or executed by a combination of hardware and software modules in the decoding processor. The software module may be located in a mature storage medium in the art, for example, a random access memory, a flash memory, a read-only memory, a programmable read-only memory, an electronically erasable programmable memory, or a register. The storage medium is located in the first memory 902, and the first processor 903 reads information in the first memory 902 and completes the steps of the foregoing methods in combination with hardware of the first processor.

It may be understood that these embodiments described in this application may be implemented by hardware, software, firmware, middleware, microcode, or a combination thereof. For hardware implementation, the processing unit may be implemented in one or more application-specific integrated circuits (Application Specific Integrated Circuits, ASIC), digital signal processors (Digital Signal Processing, DSP), digital signal processing devices (DSP Device, DSPD), programmable logic devices (Programmable Logic Device, PLD), field-programmable gate arrays (Field-Programmable Gate Array, FPGA), general-purpose processors, controllers, microcontrollers, microprocessors, and other electronic units configured to execute the functions described in this application, or a combination thereof. For software implementation, the techniques described in this application can be implemented by modules (such as processes and functions) that execute the functions described in this application. Software code may be stored in a memory and executed by a processor. The memory can be implemented in the processor or outside the processor.

Optionally, in another embodiment, the first processor 903 is further configured to run the computer program to execute the method according to any one of the foregoing embodiments.

This embodiment provides an encoder. For the encoder, a quantization parameter is set adaptively according to a first feature value of a current point cloud. Therefore, a complicated operation of searching for an optimal quantization parameter by setting values of a plurality of groups of quantization parameters according to experience may be avoided. In addition, the quantization parameter is adjusted adaptively, so that reconstruction quality of the point cloud can be improved under a condition of a limited bit rate, thereby improving encoding and decoding performance of the point cloud.

Based on a same invention concept as the foregoing embodiments, referring to FIG. 10, FIG. 10 is a schematic structural diagram of a decoder according to an embodiment of this application. As shown in FIG. 10, the decoder 100 may include a decoding unit 1001, a second determining unit 1002, and a second calculating unit 1003.

The decoding unit 1001 is configured to decode a bitstream, to determine a value of preset identification information.

The second determining unit 1002 is configured to: when the preset identification information indicates that a target setting mode is enabled for a first quantization parameter of a current point cloud, determine a first feature value based on the current point cloud.

The second calculating unit 1003 is configured to determine a value of the first quantization parameter based on the first feature value.

In some embodiments, the decoding unit 1001 is further configured to decode a bitstream, to determine the value of the first quantization parameter.

In some embodiments, the second determining unit 1002 is further configured to: determine a prediction tree corresponding to the current point cloud; and determine the first feature value based on a distance between each node and a previous node in the prediction tree.

In some embodiments, the second calculating unit 1003 is further configured to: traverse the prediction tree, perform an accumulation operation on the distance between each node and the previous node in the prediction tree, to obtain a first accumulated value, and use the first accumulated value as the first feature value.

In some embodiments, the second determining unit 1002 is further configured to: determine a prediction tree corresponding to the current point cloud; and determine the first feature value based on a prediction residual absolute value of each node in the prediction tree.

In some embodiments, the second calculating unit 1003 is further configured to: traverse the prediction tree, perform an accumulation operation on the prediction residual absolute value of each node in the prediction tree, to obtain a second accumulated value, and use the second accumulated value as the first feature value.

In some embodiments, the decoding unit 1001 is further configured to decode the bitstream, to determine the prediction residual absolute value of each node in the prediction tree.

In some embodiments, the second determining unit 1002 is further configured to: determine a reference feature value of the current point cloud; determine, based on the first feature value and the reference feature value, a feature comparison value; and determine the value of the first quantization parameter based on the feature comparison value, a preset weight value, and a basic value of the first quantization parameter.

In some embodiments, the reference feature value is a preset constant value.

In some embodiments, the second determining unit 1002 is further configured to: determine a preset reference range of the current point cloud; determine at least two second feature values based on the preset reference range; and perform mean value calculation on the at least two second feature values, to obtain the reference feature value.

In some embodiments, the basic value of the first quantization parameter is a preset constant value.

In some embodiments, the second determining unit 1002 is further configured to: determine a preset calculation model; and determine the basic value of the first quantization parameter based on a target parameter of the current point cloud and the preset calculation model, where the preset calculation model is used to indicate a mapping relationship between the target parameter and the first quantization parameter, and the target parameter includes a bit rate and/or reconstruction quality.

In some embodiments, the second determining unit 1002 is further configured to determine a first adjustment value based on the feature comparison value and the preset weight value.

The second calculating unit 1003 is further configured to perform an addition operation on the first adjustment value and the basic value of the first quantization parameter, to obtain the value of the first quantization parameter.

In some embodiments, the second determining unit 1002 is further configured to determine a second adjustment value based on the feature comparison value and the preset weight value.

The second calculating unit 1003 is further configured to perform multiplication calculation on the second adjusted value and the basic value of the first quantization parameter, to obtain the value of the first quantization parameter.

In some embodiments, the first quantization parameter includes at least one of the following: a geometric in-loop quantization parameter, a geometric out-of-loop quantization parameter, or an attribute quantization parameter.

In some embodiments, the second determining unit 1002 is further configured to: if the value of the preset identification information is a first value, determine that the preset identification information indicates that the target setting mode is enabled for the first quantization parameter of the current point cloud; or if the value of the preset identification information is a second value, determine that the preset identification information indicates that the target setting mode is not enabled for the first quantization parameter of the current point cloud.

In some embodiments, the decoding unit 1001 is further configured to: when the preset identification information indicates that the target setting mode is not enabled for the first quantization parameter of the current point cloud, decode the bitstream, to determine the value of the first quantization parameter.

In some embodiments, referring to FIG. 10, the decoder 100 may further include a second grouping unit 1004. The second grouping unit is configured to: when the first quantization parameter is a geometric in-loop quantization parameter, divide the current point cloud, to determine N groups, where N is a positive integer; determine, based on each of the N groups, a first feature value corresponding to the respective group when the preset identification information indicates that the target setting mode is enabled for a first quantization parameter of the respective group; and determine, based on the first feature value corresponding to each group, values of the first quantization parameters corresponding to the N groups.

In some embodiments, the second determining unit 1002 is further configured to: determine a sub-prediction tree corresponding to each group; and perform an accumulation operation on a distance between each node and a previous node in the sub-prediction tree, to determine the first feature value corresponding to each group.

In some embodiments, the second determining unit 1002 is further configured to: determine a sub-prediction tree corresponding to each group; and perform an accumulation operation on a prediction residual absolute value of each node in the sub-prediction tree, to determine the first feature value corresponding to each group.

In some embodiments, the decoding unit 1001 is further configured to decode the bitstream, to determine the quantity N of groups of the current point cloud.

In some embodiments, the decoding unit 1001 is further configured to decode the bitstream, to determine the values of the first quantization parameters corresponding to the N groups.

In some embodiments, the decoding unit 1001 is further configured to decode the bitstream, to determine a prediction residual value of a to-be-processed node in the current point cloud.

The second grouping unit 1004 is further configured to: determine, based on a mapping relationship between the to-be-processed node and the N groups, a value of a first quantization parameter corresponding to the to-be-processed node; perform dequantization processing on the prediction residual value of the to-be-processed node according to the value of the first quantization parameter, to determine a dequantization residual value of the to-be- processed node; and determine a reconstructed value of the to-be-processed node based on the dequantization residual value of the to-be-processed node.

In some embodiments, the second determining unit 1002 is further configured to determine a predicted value of the to-be-processed node.

The second calculating unit 1003 is further configured to perform an addition operation on the dequantization residual value of the to-be-processed node and the predicted value of the to-be-processed node, to obtain the reconstructed value of the to-be-processed node.

In some embodiments, the second determining unit 1002 is further configured to: acquire a reconstructed value of a previous node of the to-be-processed node according to a preset traversal order; and use the reconstructed value of the previous node as the predicted value of the to-be-processed node. Alternatively, the second determining unit 1002 is further configured to: acquire a reconstructed value of a previous node of the to-be-processed node and a reconstructed value of a node preceding the previous node of the to-be-processed node according to a preset traversal order; and determine the predicted value of the to-be-processed node based on the reconstructed value of the previous node and the reconstructed value of the node preceding the previous node.

It may be understood that in embodiments, the term “unit” may be a partial circuit, a partial processor, a partial program or software, or the like. Certainly, the term “unit” may be a module or may be in a non-modular form. In addition, component parts in embodiments may be integrated into one processing unit, or each of the units may exist alone physically, or two or more units may be integrated into one unit. The foregoing integrated unit may be implemented in a form of hardware, or may be implemented in a form of a software functional module.

The integrated unit may be stored in a computer-readable storage medium if it is implemented in a form of a software function module that is not sold or used as an independent product. Based on such an understanding, this embodiment provides a computer-readable storage medium, applied to the decoder 100, where the computer-readable storage medium stores a computer program, and the computer program is executed by a second processor to implement the method in any one of the foregoing embodiments.

Based on the composition of the decoder 100 and the computer-readable storage medium, FIG. 11 is a schematic diagram of a structure of specific hardware of the decoder 100 according to an embodiment of this application. As shown in FIG. 11, the decoder 220 may include a second communications interface 1101, a second memory 1102, and a second processor 1103. Various components are coupled together by using a second bus system 1104. It may be understood that the second bus system 1104 is configured to implement connection and communication between these components. In addition to a data bus, the second bus system 1104 further includes a power bus, a control bus, and a status signal bus. However, for clear description, various buses are marked as the second bus system 1104 in FIG. 11.

The second communications interface 1101 is configured to receive and transmit a signal in a process of transmitting and receiving information between the second communications interface and another external network element.

The second memory 1102 is configured to store a computer program runnable on the second processor 1103.

The second processor 1103 is configured to run the computer program to execute the following operations:
decoding a bitstream, to determine a value of preset identification information;
when the preset identification information indicates that a target setting mode is enabled for a first quantization parameter of a current point cloud, determining a first feature value based on the current point cloud; and
determining a value of the first quantization parameter based on the first feature value.

Optionally, in another embodiment, the second processor 1103 is further configured to run the computer program to execute the method according to any one of the foregoing embodiments.

It may be understood that hardware functions of the second memory 1102 are similar to those of the first memory 902, and hardware functions of the second processor 1103 are similar to those of the first processor 903, which is not detailed here.

This embodiment provides a decoder. The decoder may determine, by using only one piece of preset identification information, whether the target setting mode needs to be enabled for the current point cloud. Only when the target setting mode is enabled, the decoding end may adaptively set a quantization parameter according to the first feature value of the current point cloud. Therefore, a complicated operation of searching for an optimal quantization parameter by setting values of a plurality of groups of quantization parameters according to experience may be avoided. In addition, the quantization parameter is adjusted adaptively, so that reconstruction quality of the point cloud can be improved under a condition of a limited bit rate, thereby improving decoding performance of the point cloud.

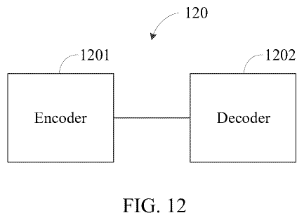

Reference is made to FIG. 12, which is a schematic structural diagram of an encoding and decoding system according to an embodiment of this application. As shown in FIG. 12, the encoding and decoding system 120 may include an encoder 1201 and a decoder 1202.

In embodiments of this application, the encoder 1201 may be the encoder according to any one of the foregoing embodiments, and the decoder 1202 may be the decoder according to any one of the foregoing embodiments.

It should be noted that in this application, the term “include”, “comprise” or any other variant is intended to cover non-exclusive inclusion, so that a process, a method, an object or an apparatus that includes a series of elements not only includes those elements, but also includes other elements that are not explicitly listed, or includes inherent elements of the process, method, object or apparatus. In the absence of further restrictions, the element limited by the sentence “including a. . .” does not exclude the existence of other identical elements in the process, method, item, or device including this element.

The foregoing sequence numbers of embodiments of this application are merely described, and do not represent advantages or disadvantages of the embodiments.

The disclosed methods provided in the several method embodiments of this application may be randomly combined with each other in the case of no conflicts, to obtain new method embodiments.

The disclosed features provided in the several product embodiments of this application may be randomly combined with each other in the case of no conflicts, to obtain new product embodiments.

The disclosed features provided in the several method or device embodiments of this application may be randomly combined with each other in the case of no conflicts, to obtain new method embodiments or device embodiments.

The foregoing descriptions are merely specific implementations of this application, but the protection scope of this application is not limited thereto. Any variation or replacement readily figured out by a person skilled in the art within the technical scope disclosed in this application shall fall within the protection scope of this application. Therefore, the protection scope of this application shall be subject to the protection scope of the claims.

### INDUSTRIAL PRACTICALITY

In embodiments of this application, at an encoding end, when a target setting mode is enabled for a first quantization parameter of a current point cloud, a first feature value is determined based on the current point cloud. Then, a value of the first quantization parameter is determined based on the first feature value. At a decoding end, first, a bitstream is decoded, to determine a value of preset identification information. Then, when the preset identification information indicates that the target setting mode is enabled for the first quantization parameter of the current point cloud, the first feature value is determined based on the current point cloud, and the value of the first quantization parameter is determined based on the first feature value. In this way, the decoding end may determine, by using only one piece of preset identification information, whether the target setting mode needs to be enabled for the current point cloud. Only when the target setting mode is enabled, the decoding end may adaptively set a quantization parameter according to the first feature value of the current point cloud. Therefore, a complicated operation of searching for an optimal quantization parameter by setting values of a plurality of groups of quantization parameters according to experience may be avoided. In addition, the quantization parameter is adjusted adaptively, so that reconstruction quality of the point cloud can be improved under a condition of a limited bit rate, thereby improving encoding and decoding performance of the point cloud.

what is claimed is:

1. A decoding method, applied to a decoder, wherein the method comprises:
decoding a bitstream, to determine a value of preset identification information;
when the preset identification information indicates that a target setting mode is enabled for a first quantization parameter of a current point cloud, determining a first feature value based on the current point cloud; and
determining a value of the first quantization parameter based on the first feature value.

2. The method according to claim 1, wherein the method further comprises:
decoding the bitstream, to determine the value of the first quantization parameter.

3. The method according to claim 1, wherein the determining the first feature value based on the current point cloud comprises:
determining a prediction tree corresponding to the current point cloud; and
determining the first feature value based on a distance between each node and a previous node in the prediction tree.

4. The method according to claim 3, wherein the determining the first feature value based on the distance between each node and the previous node in the prediction tree comprises:
traversing the prediction tree, performing an accumulation operation on the distance between each node and the previous node in the prediction tree, to obtain a first accumulated value, and using the first accumulated value as the first feature value.

5. The method according to claim 1, wherein the determining the first feature value based on the current point cloud comprises:
determining a prediction tree corresponding to the current point cloud; and
determining the first feature value based on a prediction residual absolute value of each node in the prediction tree.

6. The method according to claim 5, wherein the determining the first feature value based on the prediction residual absolute value of each node in the prediction tree comprises:
traversing the prediction tree, performing an accumulation operation on the prediction residual absolute value of each node in the prediction tree, to obtain a second accumulated value, and using the second accumulated value as the first feature value.

7. The method according to claim 5, wherein the method further comprises:
decoding the bitstream, to determine the prediction residual absolute value of each node in the prediction tree.

8. The method according to claim 1, wherein the determining the value of the first quantization parameter based on the first feature value comprises:
determining a reference feature value of the current point cloud;
determining a feature comparison value based on the first feature value and the reference feature value; and
determining the value of the first quantization parameter based on the feature comparison value, a preset weight value, and a basic value of the first quantization parameter.

9. The method according to claim 8, wherein the reference feature value is a preset constant value.

10. The method according to claim 8, wherein the determining the reference feature value of the current point cloud comprises:
determining a preset reference range of the current point cloud;
determining at least two second feature values based on the preset reference range; and
performing mean value calculation on the at least two second feature values, to obtain the reference feature value.

11. The method according to claim 8, wherein the basic value of the first quantization parameter value is a preset constant value.

12. The method according to claim 8, wherein the method further comprises:
determining a preset calculation model; and
determining the basic value of the first quantization parameter based on a target parameter of the current point cloud and the preset calculation model, wherein the preset calculation model is used to indicate a mapping relationship between the target parameter and the first quantization parameter, and the target parameter comprises a bit rate and/or reconstruction quality.

13. The method according to claim 8, wherein the determining the value of the first quantization parameter based on the feature comparison value, the preset weight value, and the basic value of the first quantization parameter comprises:
determining a first adjustment value based on the feature comparison value and the preset weight value; and
performing an addition operation on the first adjustment value and the basic value of the first quantization parameter, to obtain the value of the first quantization parameter.

14. The method according to claim 8, wherein the determining the value of the first quantization parameter based on the feature comparison value, the preset weight value, and the basic value of the first quantization parameter comprises:
determining a second adjustment value based on the feature comparison value and the preset weight value; and
performing multiplication calculation on the second adjustment value and the basic value of the first quantization parameter, to obtain the value of the first quantization parameter.

15. The method according to claim 1, wherein the first quantization parameter comprises at least one of following:
a geometric in-loop quantization parameter, a geometric out-of-loop quantization parameter, or an attribute quantization parameter.

16. The method according to claim 1, wherein the method further comprises:
if the value of the preset identification information is a first value, determining that the preset identification information indicates that the target setting mode is enabled for the first quantization parameter of the current point cloud; or
if the value of the preset identification information is a second value, determining that the preset identification information indicates that the target setting mode is not enabled for the first quantization parameter of the current point cloud.

17. The method according to claim 16, wherein the method further comprises:
when the preset identification information indicates that the target setting mode is not enabled for the first quantization parameter of the current point cloud, decoding the bitstream, to determine the value of the first quantization parameter.

18. The method according to claim 1, wherein when the first quantization parameter is a geometric in-loop quantization parameter, the method further comprises:
dividing the current point cloud, to determine N groups, wherein N is a positive integer;
determining, based on each of the N groups, a first feature value of the respective group when the preset identification information indicates that the target setting mode is enabled for a first quantization parameter of the respective group; and
determining, based on the first feature value corresponding to each group, values of the first quantization parameters corresponding to the N groups.

19. An encoding method, applied to an encoder, wherein the method comprises:
when a target setting mode is enabled for a first quantization parameter of a current point cloud, determining a first feature value based on the current point cloud; and
determining a value of the first quantization parameter based on the first feature value.

20. A decoder, wherein the decoder comprises a memory and a processor, the memory is configured to store a computer program, and the processor is configured to execute the computer program stored in the memory to cause the decoder to perform a method comprising operations of:
decoding a bitstream, to determine a value of preset identification information;
when the preset identification information indicates that a target setting mode is enabled for a first quantization parameter of a current point cloud, determining a first feature value based on the current point cloud; and
determining a value of the first quantization parameter based on the first feature value.
